(19) United States
(12) Patent Application Publication
(10) Pub. No.: US 2005/0097515 A1
(43) Pub. Date: May 5, 2005

(54) Data empowered laborsaving test architecture

(75) Inventor: Steven K. Ribling, Duvall, WA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/698,157

(22) Filed: Oct. 31, 2003

(51) Int. Cl. G06F 9/44

(52) U.S. Cl. 717/124

(57) ABSTRACT

A test program development method embodied in a data-empowered test program architecture including a test executive software module; a test framework software module having externally configurable generic software code and being coupled for interaction with the test executive software module; a plurality of software components in a software components module coupled for interaction with the test framework software module and structured for outputting one or more test reports; and one or more external control files coupled for configuring the generic software code of the test framework software module.

### FIELD OF THE INVENTION

The present invention relates to test programming methods, and in particular to software test programs for multiple test platforms.

### BACKGROUND OF THE INVENTION

The realities of the current business environment require test development departments having reduced staffs to maintain and support many legacy test programs while implement implementing new test programs. Often, each of these test programs will apply to multiple software testable line-replaceable unit (LRU) products of a single family and all configurations of those LRU products. All together, these legacy and new test programs may address both factory and field software test requirements for literally thousands of LRU configurations.

Unfortunately, traditional test development groups are unable to provide the needed additional test development and maintenance capability with current or reduced head-count, while simultaneously improving test integrity and advancing the feature set of the test programs.

FIG. 1 is a block diagram that illustrates a traditional system test architecture 1 that typically includes a test executive 3, a test program 5, a unit under test (UUT) interface 7, and a ground support equipment (GSE) interface 9. The UUT and GSE interface with one another during test, and the unit-under-test interfaces with the UUT interface 7, while the ground support equipment interfaces with the GSE interface 9. The Test Executive 3 outputs a test report 11, typically a hard copy in text format.

As a minimum, the test executive 3 contains an execution engine, which is the software responsible for controlling the execution of test sequences. Test executives can be purchased as commercial-off-the-shelf software or developed independently. Currently commercially available test executive packages contain a variety of features, but most provide at least: test sequencing capability; pass/fail analysis capability; an execution control that provides user sequences, stop-on-fail capability, sequence looping, pause and abort capabilities; and a user interface that permits the user to view the current test, view the current test results, create user execution sequences, and also provides test result reporting and sometimes includes hardware resource management functionality.

A commercial-off-the-shelf software solution eliminates development and maintenance costs. However, the commercial solution requires a run-time license fee per tester that may, when used for relatively inexpensive testers, this may represent a high relative cost that consumers are not willing to pay. Additionally, the built-in features provided by the commercial solution may not meet the project needs, thereby requiring disabling or modification of the features. Often, the commercial-off-the-shelf software feature-set does not meet the project needs. This requires some type of development and maintenance to modify or disable features and to implement the feature via independent development. Historically modifications of the commercial software feature-set have included: adding different types of pass/fail analysis, modifying the test report content and style, extending test result logging to output data in an statistical process control (SPC) format, changes to the user interface, and adding functionality. Some commercial-off-the-shelf software solutions even require a thorough understanding of the test executive's low-level architecture to make such changes.

The commercial-off-the-shelf software solution may also require the test project to become dependent on a single vendor for the software maintenance and future development. The potential for problems is present anytime a single vendor is used, not the least of which is vendor viability. The potential for reduced or discontinued product support, whether influenced by marketing or economic pressures, is always present. Since the feature-set and user interface are under the vendor's control when a commercial-off-the-shelf test executive is relied upon, changes made by the manufacturer during version updates can require developer retraining and the test programs to be rewritten. Such vendor changes can also affect the existing test program documentation. Changes to the user interface can also necessitate operator re-training in product usage. With current globalization test programs are used at shops throughout the world so that such re-training causes both the manufacturer and the end user to incur higher costs. Therefore, when a commercial-off-the-shelf software solution is selected, a product with a large installed-based from a prominent company should be used. However, developing the test executive independently can eliminate the problems associated with a single vendor.

The test program 5 performs the actual pass/fail testing of the UUT. In order to accomplish this task, the test program must perform UUT and GSE initialization, test initialization, stimulus application, response reading and test cleanup. FIG. 2 illustrates that, in any given test, the test typically interfaces with the UUT and the GSE multiple times to obtain response readings, i.e. test results, based on specific stimuli. The GSE interfaces are usually written to the driver level, which is associated with specific hardware. At the test level, each test is a custom test that is specific to the UUT and GSE. As illustrated, the tests indicated generally at 13 consist of intermixed calls directly to the UUT and GSE hardware drivers, which causes each test to be custom to the test program. Because of such specialization, tests are typically not reusable across UUTs nor GSEs, therefore a unique test program is required for each type of UUT tested.

The UUT interface 7 includes a driver that provides access to the UUT for hardware control and for data reading/writing. A monitor program, typically accessible from an RS-232 terminal program or Ethernet, typically provides access to the UUT hardware. Commands are sent to the monitor to set and read hardware states and to transmit and receive data. In an aircraft environment, this monitor is typically part of flight software or is special embedded test code such as remote-access test software (RATS) or hardware built-in test (HBIT). The UUT Interface 7 is a computer software configuration item (CSCI) that interfaces with flight code or a manufacturer's proprietary test code, such as the RATS or HBIT code. A standard UUT interface is not currently available for many manufacturers, but a standard bus access channel may be available for future LRU products.

The GSE Interface 9 provides access to the GSE hardware for control and for data reading and writing. The GSE interface 9 is another computer software configuration item, typically supplied by a vendor, that has no common or standard interface. Access to individual hardware components varies with different manufacturers and circuit cards and is performed via the drivers that are provided by the card manufacturers. Obsolescence of a component requires a driver change, which in turn requires a test program change.

Additionally, examination of the traditional test software development process exposes shortcomings in several areas that impede rapid test program development and maintainability, and may impact the quality of the finished test program. For example, test software 13 is rewritten for each test project and often for each channel of a signal. Tests are dependent on specific hardware, and test software is written for application to a particular UUT product type. Common tests operate differently on each test project and vary in completeness and rigor. This lack of test commonality also affects the test program maintainability. Since all test changes require code modification, and therefore a skilled software designer, each test program requires “experts” so that development and maintenance times are often too long to satisfy project schedules. Hardware obsolescence causes extensive code changes, which affects all test projects using the obsolete hardware. Even minor changes to requirements can cause extensive rewriting of the test program. Also, the traditional software development process is not easily adaptable to modern multi-station environments such as Highly Accelerated Stress Screening (HASS).

Use of the above traditional approach to test program development thus ties up excessive test development resources. Because of this, several methods have been tried throughout industry to overcome the inherent problems with the traditional approach. One such approach provides for use of code libraries as a method of software reuse. Another approach out-sources test program development to a user's other internal resources, test equipment vendors, or generic engineering contractors.

Though the concept of software code reuse may be effective in some instances, the use of code libraries often fails if such reuse is not built into the development process. Code libraries also require management and their use is difficult to enforce with the realities of today's overburdened development teams. Often test program developers do not know that the code libraries exist, or they feel that the code in the libraries is inferior to what they can generate. In either case, the software is often rewritten.

The use of outsourcing for test programs has been rejected by some product manufacturers for a number of reasons. One objection is that such outsourcing merely moves the shortcomings of the traditional software development process from internal development organizations to the external contractor. All of the inefficiencies remain, as do the maintenance problems. In addition, outsourcing adds a new set of challenges, such as contractor management, the need for detailed and formalized test program specifications, deployment of a test platform and LRU product to the external site, determining ownership of the finished test program and responsibility for maintenance, and maintaining security of the manufacturer's proprietary information.

Successful outsourcing often relies on a full time alliance manager for interfacing with the outsource contractor and resolving issues that surface. Since the contractor is external, access to the manufacturer's product designers is limited which requires increased management of the specification and design documents to reflect LRU product design changes during the development process. In order to allow the contractor to test the test program during development, a complete test platform and LRU product must be present at the contractor's remote site. Often this requires the manufacturer's personnel to travel to the remote site for setup or repair of the hardware. Internal maintenance of the code, with its learning curve, must be weighed against contractor maintenance, which usually has update cost and responsiveness problems. Despite confidentiality agreements, deploying specifications and LRU products to external sites carries the risk of the manufacturer's proprietary information being transferred to competitors, this is especially so in the aerospace industry given the current level of mergers and acquisitions in the industry.

While the foregoing provides an outline of the traditional test development process and architecture, current test development practices, both those of the Assignee and those within the testing industry in general have advanced the art to produce current test program development “best practices” which are discussed immediately below.

Several items have been developed that have proven effective in reducing test program development time and improving maintainability. In 1992, reusable software components were created for tasks that were not directly involved with UUT testing and that were common across all projects for a user's particular product line. These include pass/fail analysis and test report generation, UUT configuration verification and a common operator interface. A tester error-logging component was also developed.

Component commonality of the reusable software components aided the user's test designers in performing test program maintenance. Designers were now able to support multiple projects without a large learning curve. Later, it was recognized that this concept of commonality could be improved by implementing an Acceptance Test Procedure (ATP) code framework. This ATP code framework provided a template of common subroutines and variables to all projects and performed software component initialization and cleanup. Development of new projects proceeded more quickly because the test designer no longer had to create a project from scratch. A structure was in place and a large amount of code was already written and was reusable. Test program maintainability again significantly increased because the test program startup, GSE initialization, UUT initialization, launching and interfacing to the software components, and test program cleanup tasks were now performed the same way and in the same subroutines across all the user's ATP code framework-based projects.

An unplanned benefit of the ATP code framework was the ability to easily implement SPC data logging on all projects. The pass/fail analyzer software component was upgraded, and since all projects used the component and the same subroutines, the interface changes were added to one project and all ATP code framework-based projects were able to quickly add the same changes.

As discussed above, software components were developed to provide non-test-related capability across test projects. These software components were developed for specific projects but were fully documented and released as separate CSCIs. The pass/fail analyzer and report generator performs test pass/fail analysis and writes the results to the test report 11. Typically this functionality is part of a commercial-off-the-shelf test executive package.

Commonality was extended to the operator interface, whereby a component was created that provided a common look and feel to all of the user's test projects. This component was configurable so that the user's test project-specific information could be displayed to and gathered from users in addition to the standard information. When combined with a common test executive, the test operators were now able to move between projects without having to relearn anything about the test system. By using a UUT configuration matrix that is structured to list all UUT part numbers and all valid hardware and software configurations, all part numbers are displayed to the user in a drop-down list control, thereby eliminating typing errors by the operator. Once a part number is selected, the test program is able to use the configuration matrix file data to perform validation of the UUT hardware and software configurations.

A component was developed that uses the UUT configuration matrix file as an aid to manufacturing in verifying that only valid UUT configurations are shipped to customers. Accordingly, a test type value is assigned to each of a user's product configurations that identifies items that would cause the test program to branch or perform a test differently. This identification functionality allows the test program to check for UUT features, rather than UUT part numbers. Thus, as new UUT configurations are added, no changes need to be made to the test program. Using the test type approach, single test programs are able to test multiple LRU product configurations, thereby reducing the number of CSCIs that must be maintained. This file is optionally maintained by LRU product designers, whereby test designers are removed from software updating when new UUT configurations are created.

The ATP code framework was implemented after observing the large amount of time spent maintaining test programs. The lack of commonality in test program design and implementation required the maintenance person to spend considerable time becoming familiar with the test program in order to implement changes.

A second goal of the ATP code framework was to provide the software designer creating a new test project with a predefined starting place and format. This is especially useful for inexperienced programmers.

Prior to implementation of the ATP code framework, different test projects often used different subroutines for common tasks. An example is UUT power control perform among different test programs, where each test program previously used a different subroutine name for UUT power control, or used multiple subroutines in the same test program to perform this common function. With the ATP code framework, all test projects are structured to control UUT power with the same common subroutine UutPower(ON/OFF). Differences in test platforms may cause implementation of this UUT power control subroutine to vary across projects, but maintenance personnel immediately knows where to find power control.

Tables 1 and 2 illustrate the difference between pre- and post-ATP code framework code for performing UUT power control. Table 1 illustrates that different projects are often structured with different subroutines to perform a common task. In the example of Table 1, different test projects A, B, C and D use different subroutines for power control so that maintenance personnel would need to study each test program to learn how the specific project performs this task. A common problem with this approach is that maintenance personnel would make necessary changes to one subroutine, only to find out later that multiple different subroutines are used to control power. The changes would have to be duplicated until all power control subroutines were updated for the single test project.

TABLE 1
Power Control Before ATP Framework

| Project A | Project B | Project C | Project D |
|---|---|---|---|
| SetPowerOn | ApplyPower | SetAndVerifyUutPower | MessageBox “Turn Power ON” and |
| SetPowerOff | RemovePower | SetPower | MessageBox “Turn Power OFF” |
| SetPowerType | | | scattered throughout the test |
| SetPowerLevel | | | program |

Not shown in Table 1 are projects that write directly to the hardware via GPIB (general purpose interface bus) or I/O commands and do not even use a power control subroutine.

Table 2 shows that, when the ATP Framework is used, a maintenance programmer now always goes to the same subroutine UutPower to make power control changes.

TABLE 2
Power Control Using ATP Framework

All Projects
UUT Power

Use of the ATP code framework also ensures that a consistently comprehensive test report is generated. Such a report contains common information useful for troubleshooting problems remotely or satisfying Quality Assurance (QA) requirements in addition to the test pass/fail status. Such information may include: test program software module versions and file dates, times and paths; UUT configuration data; GSE configuration and calibration data; and ATP document and revision numbers.

By example and without limitation, in the aerospace industry audits by the Federal Aviation Administration (FAA) and customers repeatedly ask how verification is accomplished that the test program being used is actually the currently released software. Previously, such verification required performing an examination of the test program Version Description Document (VDD) and comparing the file dates and times against those on the test station. The ATP code framework solves this problem by containing software module verification, which performs a checksum on the test program software modules and prints pass/fail status to the test report.

Different locations where the test program is used, such as product design, repair centers, the factory and customer installations, often have different testing, interface and data gathering requirements. For example, the test program may be designed so that the factory ATP contains all tests for the UUT, while the ATP for repair and overhaul organizations and customer installations is typically a subset of all the factory tests for the UUT. The ATP code framework includes provisions controlled by a setup package, usually provided on a computer-readable disk or other computer-readable medium, to perform differently as a function of where the testing is being performed.

FIG. 3 is a block diagram of a current state-of-the-art test architecture that illustrates the traditional test architecture incorporating the software components 15a (pass/fail analyzer shown); the UUT configuration matrix 17 interfaced to the ATP code framework 19 by the operator interface and configuration component of the software components 15b; and SPC output 21. As illustrated, the component-based ATP Framework architecture 1 of current test programs has worked effectively to maximize software code reuse and to quickly add new features. The component-based ATP code framework architecture is also known to effectively permit test project-specific customization.

Additionally, the test and software industries have been working on technologies that can make development and maintenance of test programs easier. For example, a common problem for test development groups is resolving tester hardware obsolescence as products age. Changing to new hardware traditionally requires rewriting of the test program and involves investment of valuable resources. Thus, changing to new hardware can interfere with LRU product production schedules, either directly by shutting down the production line, or indirectly by tying up resources needed for new test project development. Windows NT® developed by Microsoft Corporation is a well-known example of hardware independence. By creating a Hardware Abstraction Layer (HAL), Microsoft's NT® operating system is able to run on processor chips developed by different manufacturers.

The concept of Interchangeable Virtual Instruments was developed by the IVI Foundation (www.ivifoundation.org) as an industry initiative to handle hardware obsolescence. The IVI Foundation is an open consortium of companies chartered with defining software standards for instrument interchangeability. By defining a standard instrument driver model that enables engineers to swap instruments without requiring software changes, the IVI Foundation members believe that significant savings in time and money will result. Instruments such as oscilloscopes, signal generators, digital multi-meters (DMMs) and power supplies currently support this interface.

ATLAS (Abbreviated Test Language for All Systems)-based test specifications and test programs are defined by ARINC (Aeronautical Radio Incorporated) and is also known as ARINC-626. In order to provide an alternative to the ATLAS-based test specifications and test programs, the Airlines Electronic Engineering Committee developed the ARINC 625-1 specification “Quality Management Process For Test Procedure Generation.” The ARINC 625-1 specification provides test strategy and a LRU product testability description; a UUT description, including connector pin descriptions and Input and Output (I/O) descriptions; test equipment resource requirements; a test vocabulary; predefined functions and procedures; and a detailed test specification.

ARINC 625-1 defines two separate specifications, the test specification, which is a tester independent description of the tests and the test implementation specification that describes how the test specification is implemented on specific GSE and provides shop verification of the test specification.

National Instruments Company, Inc.® of Baltimore, Md., is believed to be the current industry leader in test hardware and software. Virtual Instrument Standard Architecture (VISA) is currently National Instruments' standard method of communication with communication ports (ComPorts), GPIB (general purpose interface bus) devices, and VXI (VMEbus extension for Instrumentation) devices. All of these devices use a common interface for initialization, reading and writing. Since these devices all have a common interface to the test program, they can be changed without affecting the test program.

National Instruments Data Acquisition (NI-DAQ) is National Instruments' common interface to data acquisition devices. National Instruments' analog, digital and timer card drivers have a common set of interface functions. This common set of interface functions allows the test program to interface with multiple NI-DAQ cards without changes.

For general test program development, National Instruments provides two languages, both of which are based on a “virtual panel,” wherein a virtual panel is a collection of knobs, switches, charts and other instrument controls displayed on a computer screen that allow control of the tester hardware as a “virtual instrument.” The virtual panel can be displayed or hidden at run-time. One of the languages is LabVIEW® which is a graphical programming language having a collection of virtual instrument (VI) files. Another language is Laborsaving/CVI®, which uses LabWindows/CVI and CVI interchangeably, is an ANSI C language-based programming environment having a collection of C include (.h), source (.c) and library (.lib) files. Both languages take advantage of the VISA and NI-DAQ interfaces and provide an extensive set of test related libraries.

Although current state-of-the-art test program development architectures take advantage of the current industry and proprietary “best practices,” including the template of common subroutines and variables provide by the ATP code framework, test program development time and maintainability continue to suffer.

### SUMMARY OF THE INVENTION

A test program development method embodied in a data-driven test architecture that overcomes limitations in the traditional test program development process, incorporates best practices in place in the industry, and fulfills an ultimate goal of allowing test development personnel to operate more efficiently.

The data-driven test architecture of the invention dramatically increases test development personnel's effectiveness by significantly decreasing development time through maximizing software reuse, minimizing the amount of programming required for new test projects, and providing the test software programmer with a large quantity of tested code and a basic framework from which to launch a test project. The data-driven test architecture of the invention also lowers the programmer's required skill set, which permits non-software designers to easily create test programs and make test program changes. The data-driven test architecture of the invention increases test program maintainability by maximizing commonality between test programs, mitigating tester hardware obsolescence, reducing the test development designer's involvement in test requirements documentation and maintenance, and allows features to be easily added and disseminated to all projects.

The test program development method of the invention incorporates traditional and current test program development practices and state-of-the-art industry standards in the data-driven test architecture of the invention as a radical new approach to creating test software. The test program development method of the invention dramatically reduces development time for new test projects to the time normally needed just to gather and document requirements. Follow-on projects derived from current line-replaceable-unit (LRU) test programs can be developed in even shorter periods. Maintenance of these new test programs can be shared with LRU product designers to further reduce the burden on test program development resources.

The test program software development method described herein applies to all new test program development projects regardless of test platform hardware. Re-hosting of legacy programs is applicable on a case-by-case basis.

Utilizing the best practices, as described herein, provides a solid foundation and helps define a starting feature-set for the novel test program development method of the invention. Additionally, any shortcomings in these best practices are identified and rectified in practicing the novel test program development method of the invention. These best practices are also extended to achieve the full potential of the novel test program development method of the invention.

As utilized by the novel test program development method of the invention, the best practices, as described herein, are effective in reducing test program development time and reducing test program maintenance costs and time. Accordingly, test program development best practices provide commonality in test software components that reduces maintenance time and costs, reusability of software components reduces test program development time, and use of component-based architecture enhances reuse, feature sharing and propagation of new test features. Additionally, a common test framework provides a common starting place, i.e., template, for all new test projects; enforcement of software component reuse incorporates component reuse into the test program development process, cross-project commonality enhances reduction of maintenance time and costs; basic software component interfacing reduces the learning curve for a software designer on a new test project; utilization of hardware abstraction interfacing, virtual instruments, NI-DAQ analog, digital and timer card drivers, and VISA interfaces help mitigate tester hardware obsolescence. Furthermore, use of common tester hardware across test projects reduces hardware abstraction interface coding to a level of write once and reuse. Use of a hardware abstraction layer (HAL) permits the test program to run on processor chips developed by different manufacturers so that the data-driven test architecture of the invention is able to run on PXI, PCI and VXI test hardware originating from a variety of different manufacturers, without coding changes.

The test program development method of the invention as embodied in the data-driven test architecture described herein thus significantly decreases test program development time. For example, test program development time is decreased in some instances from 1 year or more for current test program development projects, to as little as 8 to 10 weeks. The test program development method of the invention thus so significantly reduces test program development time that a single test program designer is able to complete up to five test program projects in the time it currently takes to complete one. This dramatic decrease in test program development time is accomplished by maximizing software component reuse by utilizing the reusable novel test executive, test framework and software components of the invention. The amount of programming required for new projects is thus minimized. As discussed herein, new test program projects only require the creation of one or more control files so that new test program development requires virtually no new programming effort. Rather, the test program development method of the invention as embodied in the data-driven test architecture described herein provides the test programmer with a large amount of tested code and a framework from which to start a new test program project. The invention thus lowers the skill set required of the test program designer, thereby permitting non-software engineers to easily create tests and make changes to test programs developed using the data-driven test architecture of the invention.

Creation of the control files utilized by the data-driven test architecture of the invention does not require any programming. The test program developer only needs knowledge of the UUT. This is in contrast to the traditional test program development process wherein the test program developer must know how to interface to the UUT and GSE and must know how the UUT operates. The test program development method of the invention as embodied in the data-driven test architecture described herein increases test program maintainability because the test programs reside in a control file, herein named a test properties control file, so that no code maintenance is required. Furthermore, according to the test program development method of the invention, all test programs use the same test executive, test framework and software components so that commonality between test programs is maximized. The test program development method of the invention as embodied in the data-driven test architecture described herein mitigates tester hardware obsolescence by incorporating a hardware abstraction layer that separates the test program from the hardware interface. The same test program can therefore be executed on different hardware platforms, such as PCI, PXI and VXI, without code changes.

The test program development method of the invention reduces involvement of the test program developer in test requirements documentation and maintenance because, as embodied herein, the test program development method of the invention utilization of test database permits LRU product designers to create and maintain test program requirements.

The test framework of the invention as described herein is easily updated for use by all projects so that the test program development method of the invention permits test features to be easily added and disseminated to all test projects.

The test program development method of the invention thus change focus of test program development personnel from the firefighting mode typical today to one of process and test improvement. Some of the process benefits provided by the test program development method of the invention are that documentation becomes part of the test program development process, and software reuse becomes the core of the test program development process.

One common problem that is overcome by the test program development method of the present invention is that known state-of-the-art test development methods do not completely capture test requirements prior to coding. The test program development method of the invention overcomes this problem by the data-driven test architecture of the invention as described herein requiring a complete test implementation specification test description before it will operate. Test program creation is thus moved from the coding phase to the requirements phase of the project.

Another problem with known state-of-the-art test development methods is that test parameters must be written to multiple places: the test specification, the test implementation specification, and the test program. The data-driven test architecture of the invention overcomes this problem by utilization of the test database, whereby all test parameters information is entered once and used in multiple places in the test program.

Additionally, known state-of-the-art test development methods require multiple document changes when test limits change. Such changes often occur multiple times in the test program when the same limits are used for multiple channels in the test program. The test database of the present data-driven test architecture handles all test limit changes so that no code changes are required.

Yet another problem with known state-of-the-art test development methods is that code providing tests and functionality is often rewritten for each test program project. The data-driven test architecture of the invention eliminates such duplication of coding by moving the test program to control files. Additional project-specific “helper” functions, as described herein, are incorporated into the test framework of the invention as appropriate.

The test program development method of the invention as embodied in the data-driven test architecture described herein also provides support for asynchronous multi-station ATP and HASS testing. Multi-station ATP testing permits more manufacturing throughput with a single tester, which reduces the number of testers required and thereby reduces capital costs.

Accordingly, the test program development method of the invention is embodied in a data-empowered test program architecture having one or more external control files that include an external control file having a list of test identification (test ID) numbers; a novel test executive module having an execution engine coupled to receive one or more test ID numbers from the list of test ID numbers for generating as a function of the test ID a plurality of test actions to be performed on a UUT; a test framework that accesses the plurality of test actions and associated test equipment hardware resources as a function of the test ID number, wherein the test framework determines an identification of one of the test equipment hardware resources associated with a current one of the test action, retrieve the identification of the associated test equipment hardware resource, determine a signal type corresponding to the retrieved test equipment hardware resource identification, access as a function of the signal type one of the external control files having test equipment hardware resource card-type information, and determine the test equipment hardware resource card-type information as a function of a card-type identifier.

According to another aspect of the invention, the test equipment hardware resource card-type information of the data-empowered test program architecture includes routing data and parameters for interfacing with an external hardware driver.

According to another aspect of the invention, the data-empowered test program architecture further includes an external reuse library having a plurality of test descriptions corresponding to a plurality of different test signal types.

According to another aspect of the invention, the data-empowered test program architecture further includes a plurality of software components for interfacing between the external control files and both the test executive module and the test framework module.

According to another aspect of the invention, the plurality of software components provided in the data-empowered test program architecture of the invention further includes one or more modes of pass/fail analysis and test reporting.

According to yet other aspects of the invention, the test program development method of the invention is embodied as a computer program product provided on a computer usable medium having computer-readable code embodied therein for configuring a computer, the computer program product providing computer-readable code configured to cause a computer to generate a plurality of test actions; computer-readable code configured to cause the computer to access the plurality of the test actions; computer-readable code configured to cause the computer to identify a test equipment hardware resource associated with a current one of the test action; and computer-readable code configured to cause the computer to interface with an external hardware driver as a function of the test hardware resource associated with the current test action.

According to another aspect of the computer product embodiment of the invention, the computer-readable code that is configured to cause the computer to interface with an external hardware driver further includes computer-readable code configured to cause a computer to: determine a signal type corresponding to the identified test hardware resource; access as a function of the signal type an external control file having test hardware resource card-type information contained therein; and determine the test hardware resource card-type information as a function of a card-type identifier.

According to another aspect of the computer product embodiment of the invention, the computer-readable code that is configured to cause the computer to generate a plurality of test actions further includes computer-readable code configured to cause the computer to receive from a list of test ID numbers one or more test ID numbers, and to generate the plurality of test actions as a function of the received test ID number.

According to another aspect of the computer product embodiment of the invention, the computer product further includes computer-readable code configured to cause the computer to perform a pass/fail analysis and to generate one or more test reports.

According to another aspect of the computer product embodiment of the invention, the computer product further includes computer-readable code stored in one or more software components and configured to cause the computer to interface between the computer-readable code configured to cause the computer to generate a plurality of test actions and the computer-readable code configured to cause a computer to access the plurality of the test actions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram that illustrates a traditional system test architecture;

FIG. 2 illustrates that, in any given test, the test typically interfaces with the unit-under-test and the ground support equipment multiple times to obtain response readings based on specific stimuli;

FIG. 3 is a block diagram of a current state-of-the-art test architecture;

FIG. 4 and FIG. 5 are top-level and high-level block diagrams, respectively, that together illustrate one embodiment of the data-empowered test architecture of the invention for test program development;

FIG. 6 illustrates the project-specific control/support file interfacing of the data-empowered test architecture of the invention embodied in a mid-level architecture diagram;

FIG. 7 illustrates a sample test description of the invention;

FIG. 8 illustrates the common test procedure source for both the test implementation specification and the test properties control file, wherein the test procedure data are optionally exported from the database to both the test implementation specification and the test properties file of the data-empowered test architecture of the invention, in their respective formats;

FIG. 9 is an exemplary illustration of one embodiment of a test procedure portion of the test implementation specification test description illustrated in FIG. 7 wherein the example illustrated is an analyze mode test procedure of the invention;

FIG. 10 compares traditional signal-specific tests of the prior art systems to the generic data-driven test provided by the data-empowered test architecture of the invention;

FIG. 11 illustrates test execution using the test procedure interpreter of the invention;

FIG. 12 illustrates the test framework of the invention embodied in a block diagram wherein a SET action is illustrated;

FIG. 13 illustrates the interface of the test framework of the invention to the hardware abstraction interface of the invention as embodied in a block diagram;

FIG. 14 illustrates the operation of the hardware abstraction interface of the invention with commercial off-the-shelf vendor drivers embodied in a block diagram;

FIG. 15 is a block diagram that embodies an exemplary summary of the steps of the test procedure of the invention for interfacing with low-level vendor-supplied hardware drivers; and

FIG. 16 illustrates an exemplary “helper” function of the invention.

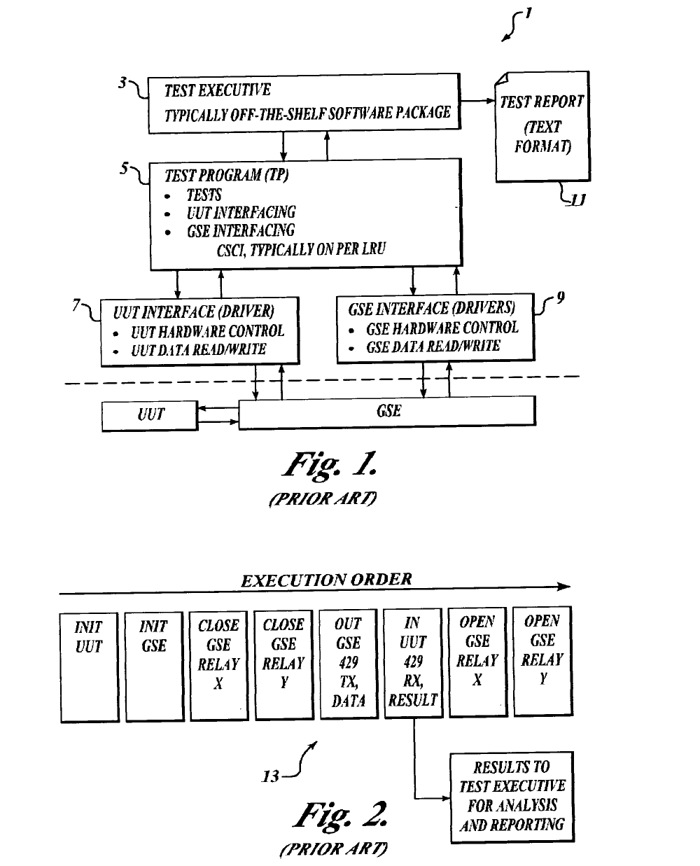

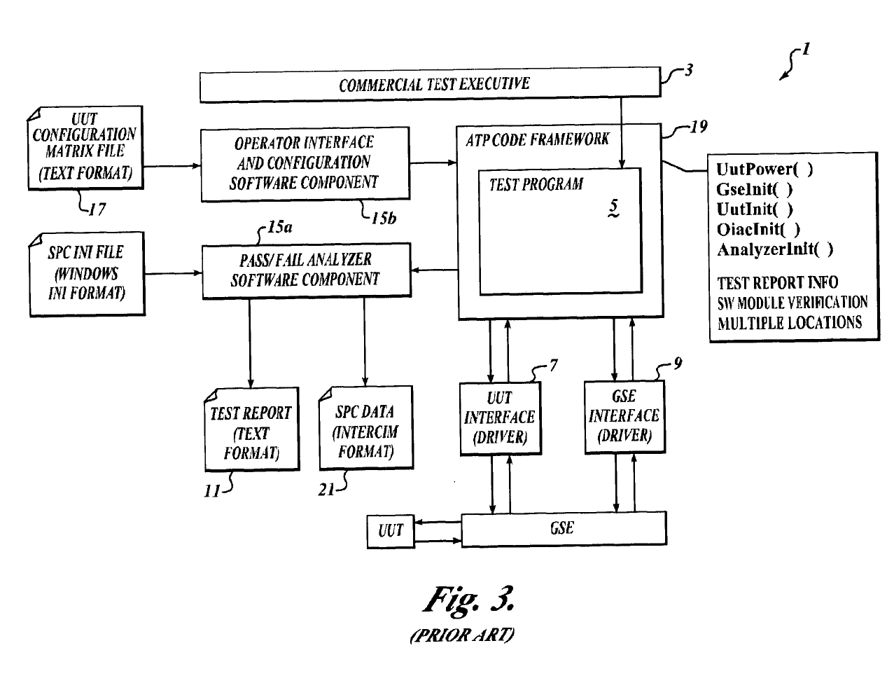

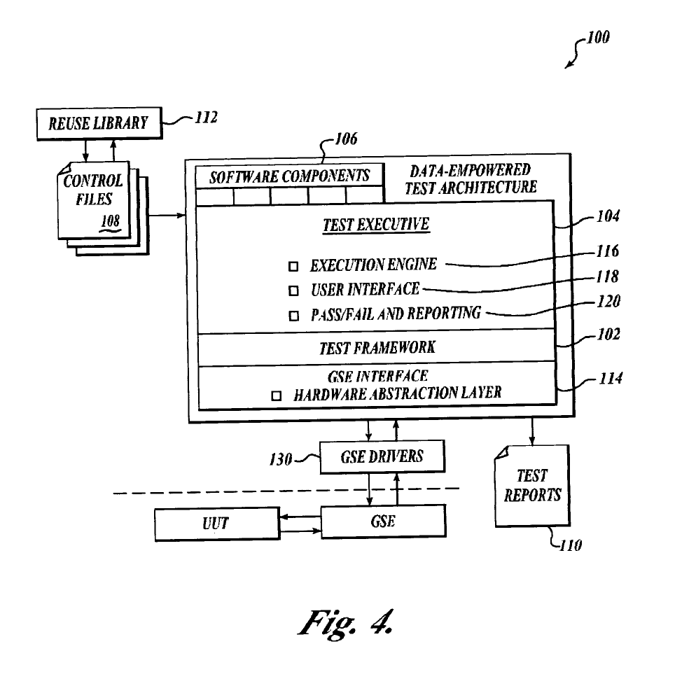

### DETAILED DESCRIPTION OF PREFERRED EMBODIMENT

In the Figures, like numerals indicate like elements.

The test architecture of the invention is embodied in a data-empowered test architecture that overcomes the shortcomings in the traditional test program development process, incorporates best practices in place in the industry, and fulfills the ultimate goal of allowing test development engineers to operate more efficiently.

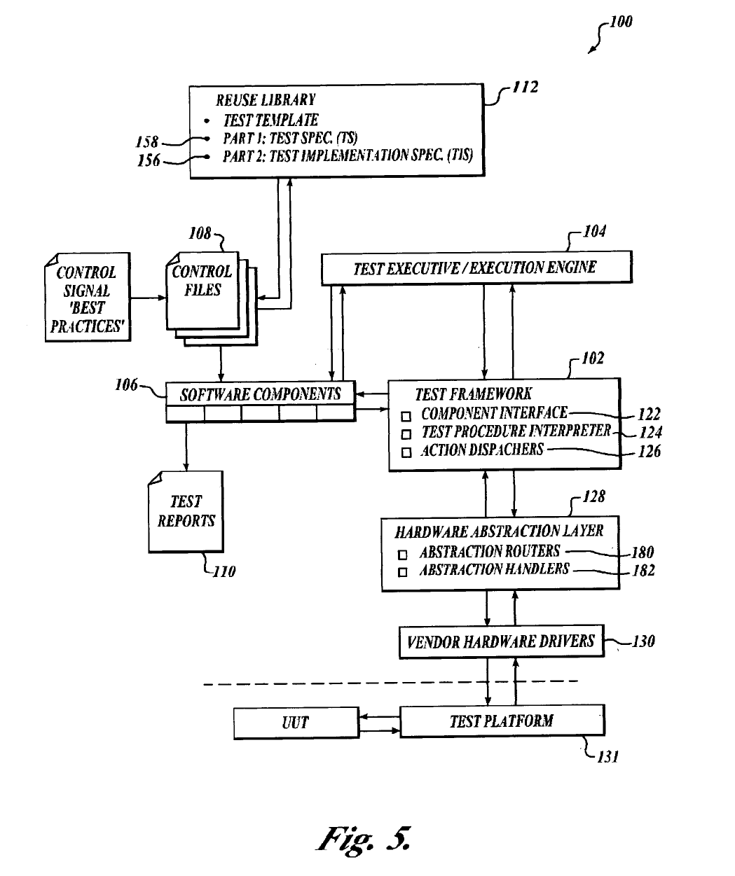

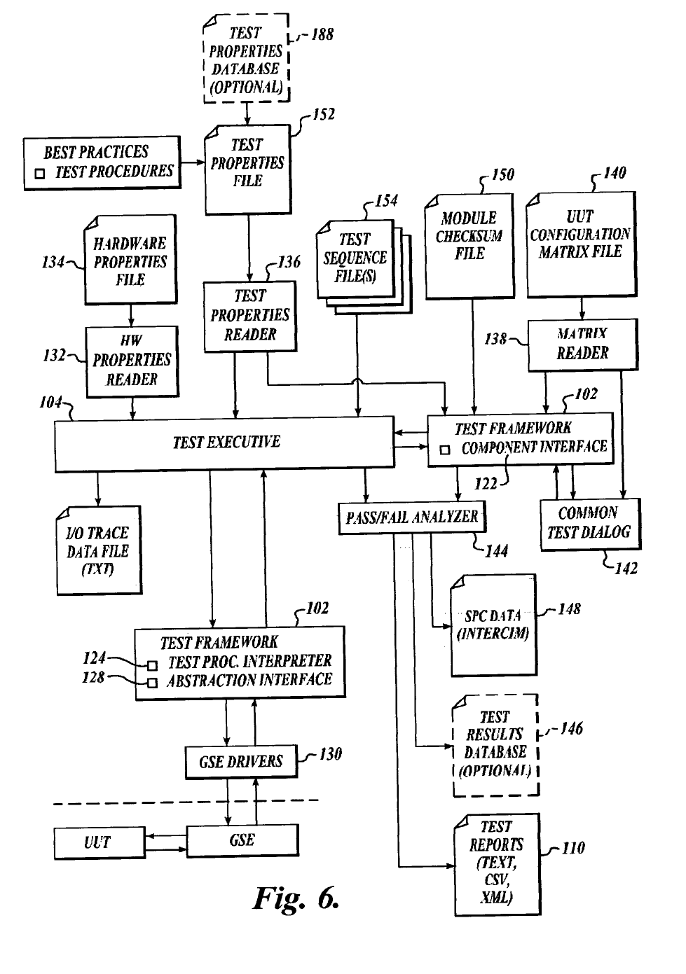

FIG. 4 and FIG. 5 are top-level and high-level block diagrams, respectively, that together illustrate the test program development method of the invention embodied in a data-empowered test program architecture 100 that utilizes a test framework module 102, a test executive module 104, a plurality of software components in a software components module 106, and one or more external control files 108. hardware abstraction included in the architecture enables the code-base of the data-empowered test architecture of the invention to work with virtually all current tester hardware, including by example and without limitation all of PXI, PCI, VXI.

The code-base of the data-empowered test architecture 100 of the invention illustrated in the top-level block diagram of FIG. 4 is generic and configured by external control files 108 to test the unit-under-test (UUT) and generate one or more test reports 110. Because it is data-driven, the data-empowered test architecture 100 of the invention provides the developer of a new test project with virtually all code required for a test project. The data-empowered test architecture 100 of the invention thereby reduces new test project development is thereby reduced to creating one or more control files 108 to configure the data-empowered test architecture. An external reuse library 112 is a useful reference for program developers in creating the control files 108 and includes test descriptions of common signal types used across a using manufacturer's products. This is a “best practices” test methodology that captures lessons learned from experience.

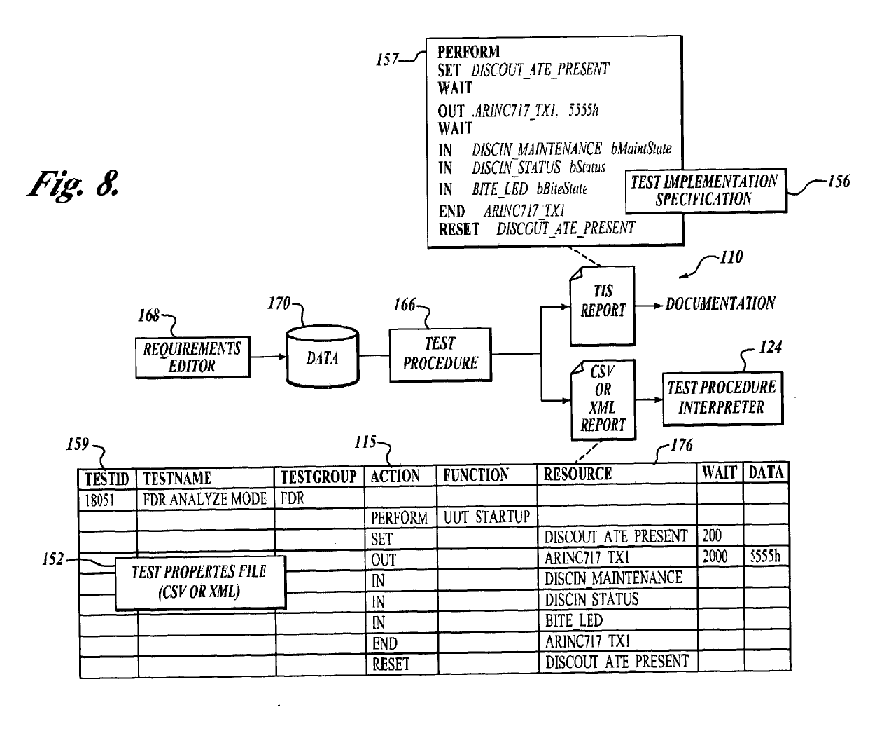

The code-base of the data-empowered test architecture of the invention that is furnished to each project is debugged and tested. For example, the test framework 102, test executive 104 and software components 106 of the data-empowered test architecture 100 are developed under well-known capability maturity model level 2 processes which are much more comprehensive than the DO-178B Level E processes normally associated with test program development. The debugged and tested code-base of the data-empowered test architecture is contained in the test framework module 102, the test executive module 104, the software components module 106, and a ground support equipment (GSE) interface module 114 for driving the ground support equipment. These modules and the external reuse library 112 are optionally standalone executables, Dynamic Link Libraries (DLL), test descriptions 157 (shown in FIG. 7), or code that is ready to be linked into the new test project.

The data-empowered test architecture software: test framework module 102, test executive module 104, and all software components of the software components module 106, are provided as separate CSCIs (computer software configuration items). Each test program is also a separate CSCI that may include the system software as part of a test program setup package stored on a computer disk or other computer-readable medium. By including all software as a single setup package, i.e., computer disk, except vendor-supplied hardware drivers, the correct version of each component is captured as part of the test program.

Test programs include the following common CSCIs: the data-empowered test architecture test framework 102, test executive module 104 and software components module 106 that includes a pass/fail analyzer and report generator (PFARG), a test properties reader (TPR) 136, a hardware properties reader (HPR) 132, a common test dialog (CTD) 142, and a UUT configuration matrix access and verification (CMAV) reader 138. When the test platform hardware is configured, a hardware properties control file (HPF) 134 is created by the platform hardware designer. This file is released as part of the hardware configuration control package. The hardware properties control file 152 is installed on the test platform and the name and path of the hardware properties control file 152 are entered into the operating system registry so the data-empowered test architecture software of the invention is able to locate it.

According to one embodiment of the invention useful for aircraft cockpit line-replaceable unit (LRU) products, each test program additionally includes an ARINC 625 test specification (TS) 158, an ARINC 625 test implementation specification (TIS) 156, a test properties control file 152, a UUT configuration matrix file 140, a software module checksum file 150, formal test sequence control files 154, and any project specific code.

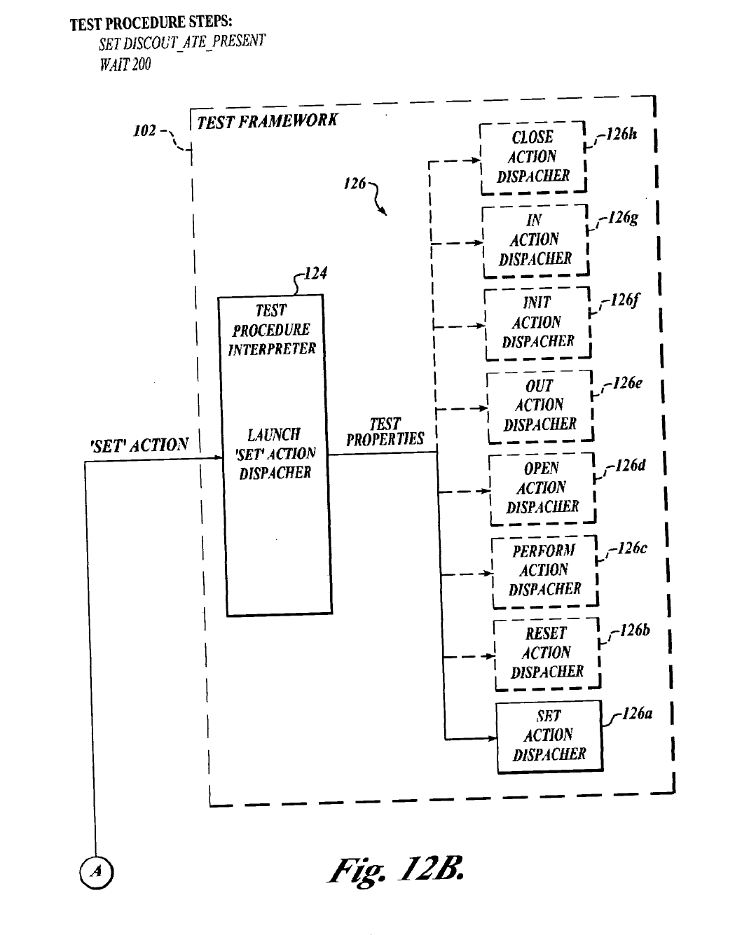

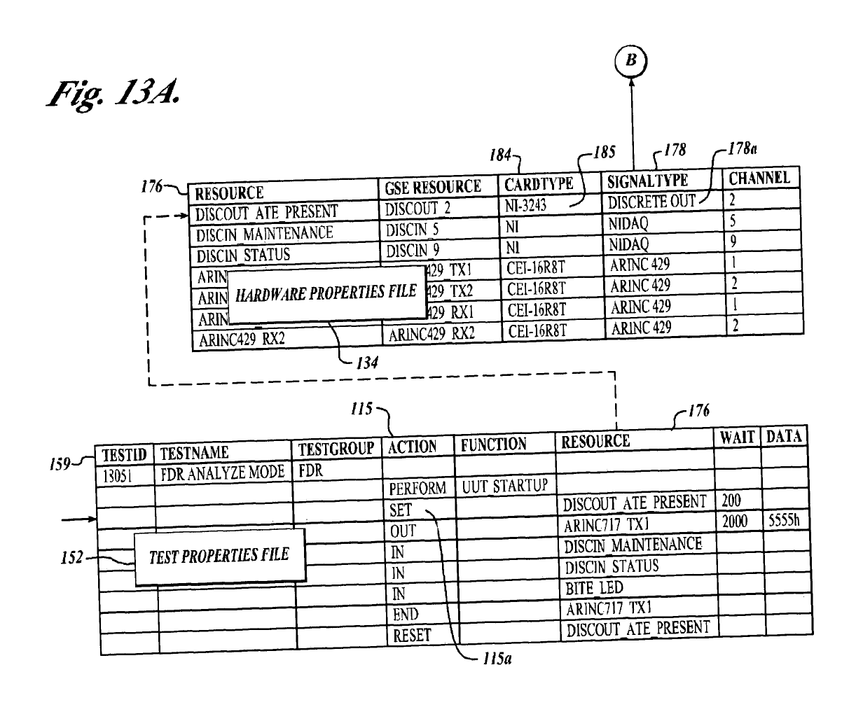

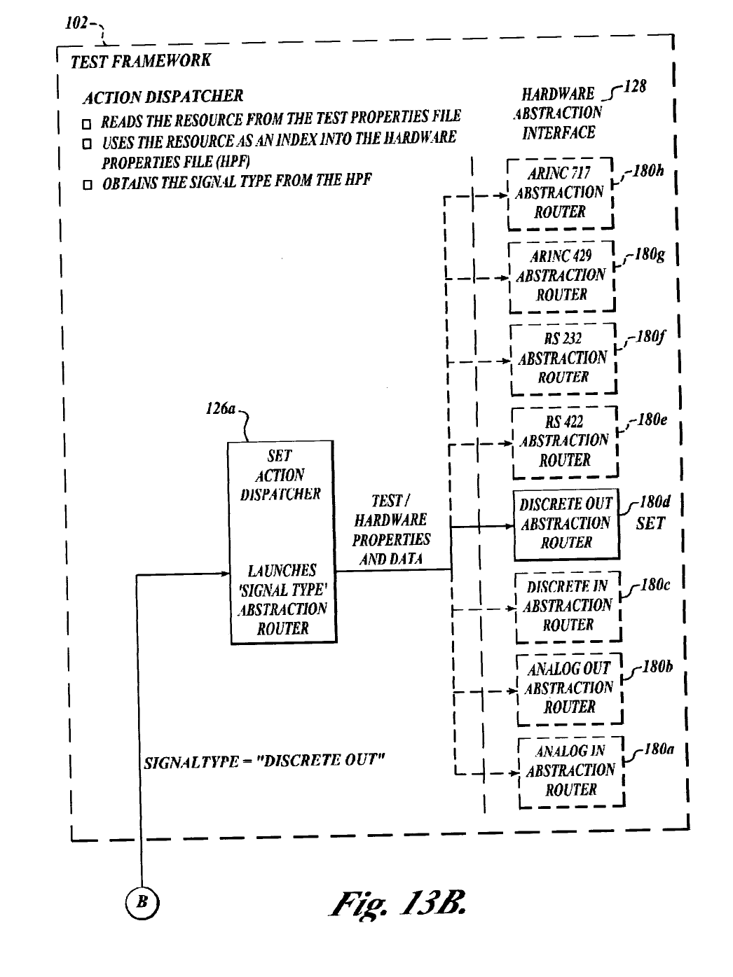

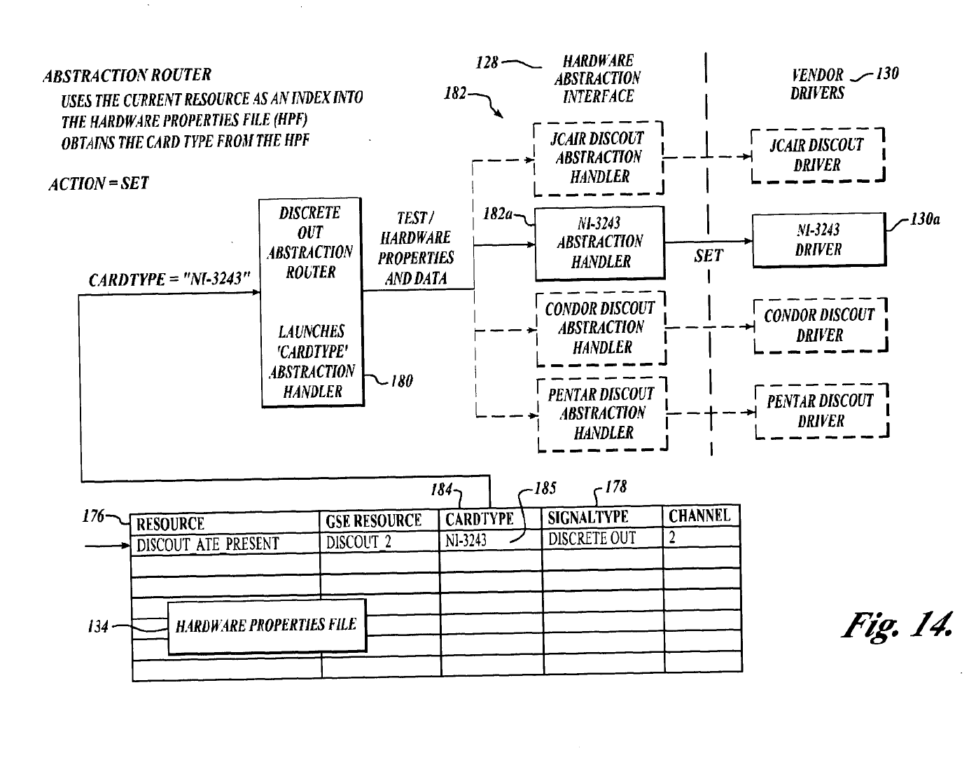

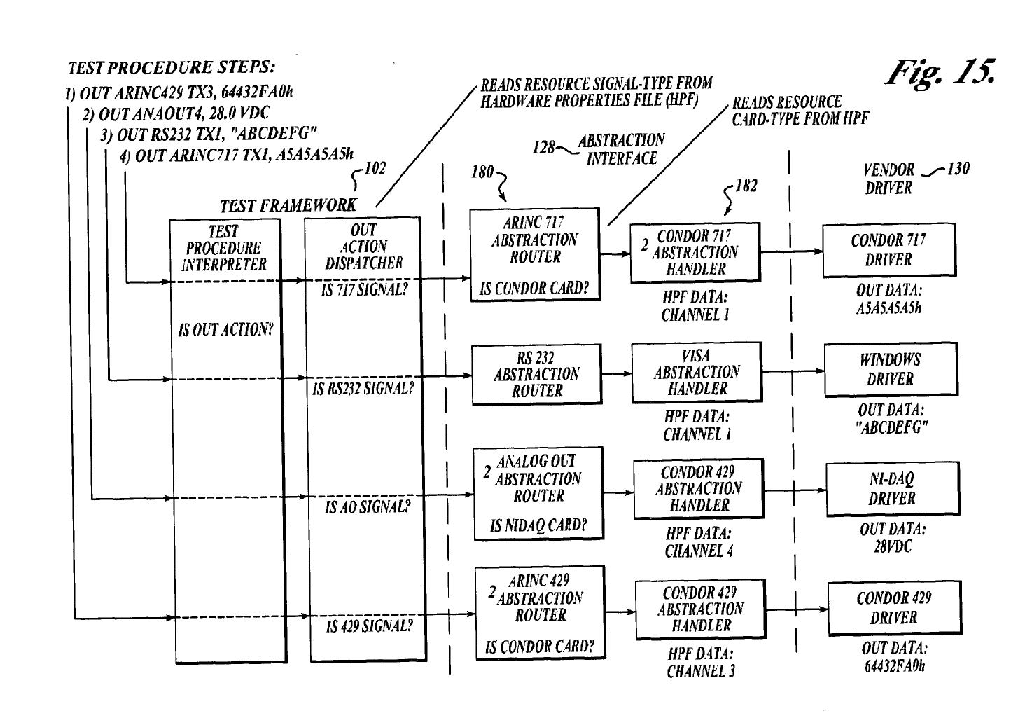

Operation of the data-empowered test architecture 100 of the invention is most clearly illustrated in FIG. 11. Accordingly, as discussed in detail below, the one or more external control files 108 created by the test development engineers provides a list of test identification (test ID) numbers 159 that are contained in a test sequence control file 154. The test ID numbers 159 are used by an execution engine 116 portion of the test executive module 104 to provide a sequence of test operations or “actions” 115 to be performed on the UUT. The execution engine 116 steps through the test ID numbers 159, passing the test ID numbers 159 one at a time to a test procedure interpreter 124 portion of the test framework module 102. The test procedure interpreter 124 uses the test ID number 159 to access a plurality of the test actions 115 and associated test equipment hardware resources 176 stored in a spreadsheet-formatted test properties control file 152. The test procedure interpreter 124 determines the name of a test equipment hardware resource 176 associated with the current test operation or action 115. The test procedure interpreter 124 retrieves the name of the associated tester hardware resource 176, and passes the tester hardware resource 176 name to an action dispatch and routing module 173 portion of the test framework module 102. As illustrated in FIGS. 12 and 13 and discussed in detail below, a portion of the action dispatch and routing module 173 determines a signal type 178 corresponding to the retrieved hardware resource 176 name, whereupon control is passed to the hardware abstract interface (HAI) 128. As illustrated in FIGS. 14 and 15 and discussed in detail below, the hardware abstract interface 128 uses the signal type 178 to access the hardware properties control file 134 and determine the hardware resource card-type 184 as a function of a card-type identifier 185, such as “NI-3243” illustrated in FIGS. 13 and 14. The hardware abstract interface 128 is thereby enabled for routing data and parameters to and from vendor-supplied hardware drivers, i.e., interfacing with the vendor-supplied hardware drivers.

The data-empowered test architecture 100 of the invention uses a novel test executive 104 that includes a novel multi/single-unit execution engine 116, a novel proprietary user interface 118, and novel pass/fail analysis and reporting processes 120 provided by the software components module 106. The multi/single-unit execution engine 116 includes built-in hardware resource management capability, support for user-defined sequences, and execution control that provides such control features as: stop-on-fail, sequence looping, skip test, skip test group, pause and abort functions. The user interface 118 provides a GSE status view, and a UUT view that includes a test report view, a test status view, and an instrument I/O trace view. The pass/fail analysis and reporting process 120 is optionally a commercial product provided as part of the software components module 106, and includes built-in support for statistical process control (SPC) reporting, for example in a conventional spreadsheet format such as an XML (eXtensible markup language) format. However, limitations related to these functions in commercial test executives caused this functionality to be broken-out into a component. Additional logging modes are included along with additional testing types.

The novel test executive 104 of the invention includes several features that are not available in a commercial off-the-shelf executive. Modification of a commercial off-the-shelf executive to incorporate these features may be possible, but such modification is not cost effective due to the additional developer training required and the additional time and resources needed to create and maintain the modified executive.

In smaller development teams allowing developers to create software in whatever language with which they are most comfortable may be problematic. For example, if programmer leaves the team or becomes unavailable, the code becomes non-maintainable unless another programmer on the team is familiar with the language.

An ability to run modules built from multiple languages, as is provided by one or more commercial off-the-shelf executives, is not needed when a development language is selected that allows the test executive 104 to run Dynamic Link Libraries (DLLs) built from any language, as discussed herein. The multi-language support feature present in some commercially available executives does not provide any advantage in the environment of the data-empowered test architecture of the invention at least because so little programming is performed when creating a new test program. For maintenance purposes, it is important not to abuse multi-language support provided by any test executive.

The novel test executive 104 utilized by the data-empowered test architecture of the invention provides dynamic test sequencing that is controlled by the external control files 108. The novel test executive 104 also provides a user interface that supports either an Acceptance Test Procedure (ATP) or a Highly Accelerated Stress Screening (HASS) environment and additional pass/fail analysis modes beyond those normally provided by commercial test executives. The novel test executive 104 permits formatting of the test report 110. Furthermore, the novel test executive 104 provides the report data to be output in SPC format to support SPC programs. The novel test executive 104 supports multi-station testing by providing built-in tester hardware resource management, but utilization of the test executive 104 of the invention avoids the run-time license fees associated with commercial test executives.

A major problem in the prior art is a lack of consistency in common signal-type tests across projects. According to the set of test descriptions provided by the external reuse library 112, all projects test the same signal-types in the same way according to a set of test requirements defined for each signal-type and a set of test descriptions that have a high degree of completeness and rigor.

The reuse library test descriptions are optionally shared across a using manufacturer's product lines to provide a common test methodology to all internal test programs, whether or not the data-empowered test architecture of the invention is utilized. The following is a sample test description 157 of the test implementation specification 156 for ARINC 429 receiver testing.

In an aircraft environment, outputs of avionics on the aircraft are present as data signals on the aircraft ARINC-429 serial bus and consist of 32-bit packets. The packets are defined in Table 3.

TABLE 3

| BIT | DESCRIPTION |
|---|---|
| 0 . . . 7 (8 bits) | Signal Label. An octal word that |
| | identifies the avionics sending |
| | the data and therefore the signal type. |
| 8 . . . 30 (23 bits) | Data. The format of the data |
| | and its meaning varies depending |
| | upon the type of signal. |
| 31 (1 bit) | Parity. A ‘1’ indicates odd parity. |

In the special case of an aircraft LRU product the LRU product is capable of accessing the aircraft ARINC-429 serial bus and monitoring the outputs of other avionics on the aircraft to obtain information on current flight parameters. The aircraft may have several ARINC-429 buses that operate at one of two speeds: High (100 KHz) or Low (12.5 KHz). The LRU product is capable of accessing and “listening” to these buses to obtain relevant data such as altitude, air speed, flap position, and other relevant data. The ARINC 429 transceiver chips are optionally programmed to only accept certain Labels, which allows the LRU product to do selective “listening” such that data packets from non-selected avionics are ignored.

ARINC-429 input tests are performed to verify that the LRU product's hardware is capable of correctly receiving data at both High and Low speeds. Testing is provided by transmitting data packets from the GSE to each of the LRU product's receiver channels and verifying, via the appropriate UUT interface, that the correct data was received, that the data was received on the correct channel, and that the timestamp for the data is present. The data packets chosen for testing are selected to provide short/open checking on the ARINC 429 data bus. By example and without limitation the data packets on the ARINC 429 data bus for testing include: Signal Label, which is an octal word that identifies the avionics sending the data and therefore identifies the signal type; Data, having a formats and meanings that vary depending upon the type of signal; and Parity. Testing is also designed to perform the more thorough testing at high speed in order to minimize test time.

The Low Speed Input Testing of the LRU product's receiver channels includes data verification and low amplitude threshold testing. These tests are combined to minimize test time. Typically, no attempt is made to verify the Label Recognition or Parity functions of the ARINC-429 Receivers, since these are either tested as part of the BITE or as a separate test.

The High Speed Input Testing of the LRU product's receiver channels includes data checking, and time stamp verification. A normal signal amplitude is used during this test. No attempt is made to verify the Label Recognition or Parity functions of the ARINC-429 Receivers, since this is tested as part of the BITE or as a separate test.

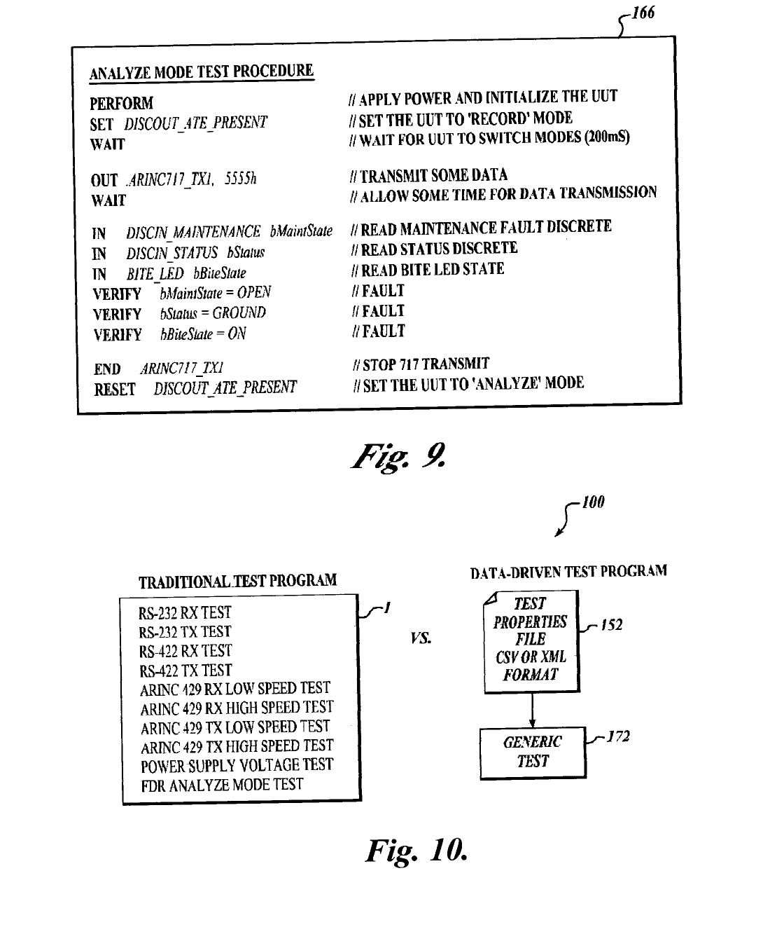

The reuse library 112 is in two parts: the test specification (TS) 158 and test implementation specification's test descriptions 157 for all common signal testing, wherein a Phase 1 is a text document template in a word processing format such as a conventional document template, and wherein a Phase 2 is a user test database; and a spreadsheet control file template for insertion into a project test properties file, shown in FIG. 8.

According to the invention, the reuse library 112 is dynamic and is updated as test projects add new signals or advance the signal testing methodology. Changes made for one project are thereby available for all other projects to use. LRU product engineering personnel also use the test descriptions of the reuse library 112 when specifying test requirements.

The test framework embodied in the test framework module 102 provides the following functional blocks: a component interface 122; a test procedure interpreter (TPI) 124; action dispatchers (AD) 126; and the hardware abstract interface (HAI) layer 128 having both abstraction routers 180 and abstraction handlers 182, shown in FIG. 13.

The component interface 122 represents incorporation of test program development best practices as known in the prior art and discussed above, and provides the functionality described in regard to the ATP code framework as known in the prior art and discussed above. Briefly, it provides interfacing to and setup of the software components 106 and also provides a common set of subroutines that are used to perform UUT and GSE initialization. These subroutines reference procedures, such as GseInit (GSE initiation), UutInit (UUT initiation) and UutPower (UUT power), which are present in the test properties file, shown in FIG. 8.

In order to make the data-empowered test architecture 100 of the invention effectively data-empowered or “data-driven,” the system software contains generic code that is configurable by external control files 108 to perform specific UUT tests. This ability to be configurable by external control files is performed by the test procedure interpreter 124 portion of the test framework 102 which processes the test procedure vocabulary of the test implementation specification.

Hardware abstraction, as known in the prior art, is extended to the test program by incorporation in the hardware abstract interface 128 which separates the test program from the hardware interface and permits the data-empowered test architecture 100 of the invention to run on conventional PXI, PCI and VXI test hardware from a variety of manufacturers, without coding changes. The hardware abstract interface 128 thereby mitigates tester hardware obsolescence and to permits the test framework module 102 to accommodate all test projects. As discussed herein, the hardware abstract interface 128 interfaces with vendor-supplied hardware drivers 130, which drive the test platform 131 having the GSE for interfacing with the UUT.

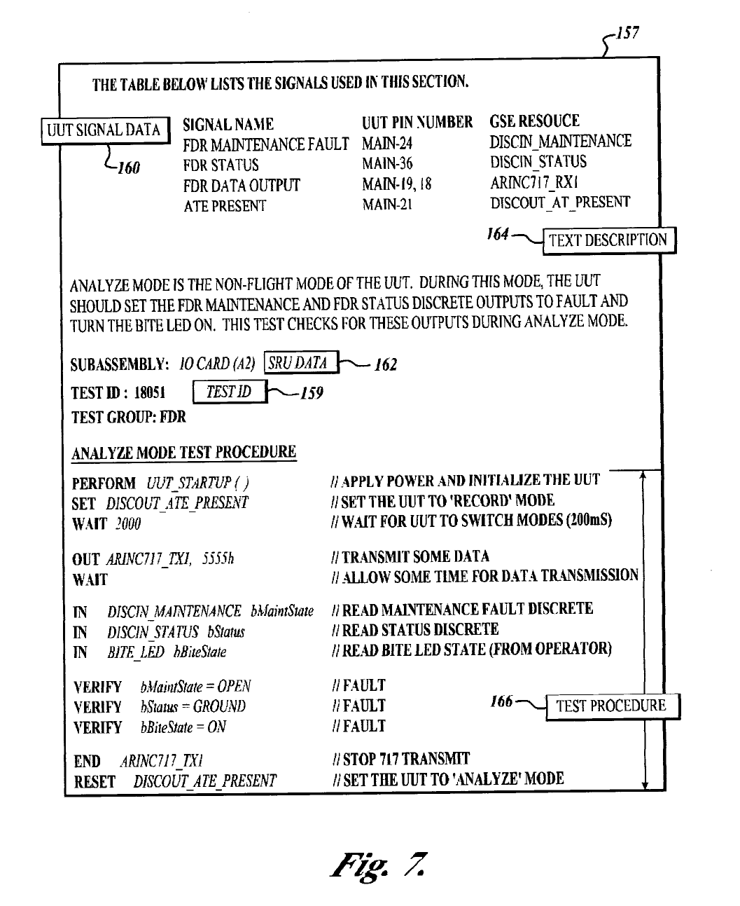

FIG. 6 is a mid-level architecture diagram of the data-empowered test architecture 100 of the invention that illustrates test project-specific control/support file interfacing. As described in the prior art and discussed herein, the use of software components has been known to increase software reuse and commonality. The software components known in the prior art and described herein are included in the data-empowered test architecture 100 of the invention. In addition, components that perform interfacing to the external control files 108 are added to the suite of software components contained in the software components module 106. The software components module 106 thus includes the following software components: the hardware properties reader (HPR) 132 that provides interfacing to the hardware properties file (HPF) 134 which is one of control files 108; the test properties reader (TPR) 136 that provides interfacing to a test properties files 152 which is another one of control files 108; the UUT configuration matrix access and verification (CMAV) reader 138 that provides access to a UUT configuration matrix file 140 which is another one of control files 108; the common test dialog (CTD) 142; and a pass/fail analyzer and report generator (PFARG) 144 that provides several modes of pass/fail analysis as well as providing test reporting. The pass/fail analyzer and report generator 144 supports SPC data collection which is used to track UUT performance and to improve product yields. Optionally, the test data is output to a Results Database 146 for use in improving test rigor and comprehensiveness. For example, the pass/fail analyzer and report generator 144 outputs both test reports 110 and statistical process control (SPC) data 148 in format structured to support SPC programs. The common test dialog 142 provides data gathering for the test program, including for example the operator name, the UUT serial number, the UUT part number and the test report modes. Furthermore, the common test dialog 142 provides data display for the test program, and is configurable to suit the test project.

The data-empowered test architecture 100 of the invention is data-driven by use of the external control files 108 which are optionally configured as one or a plurality of external control files 108 and include: the UUT configuration matrix control file 140 which contains data relating to all hardware resources 176 present in the test platform 131; a check sum control file 150; one hardware properties control file 134 per tester; one test properties control file (TPF) 152 per test program set (TPS), which contains all test data; test sequence control files 154 having an Acceptance Test sequence, a return-to-service sequence, and other user-defined sequences. Tester hardware configuration control is enforced by coupling through the hardware properties file 134 of the data-empowered test architecture 100. Unknown or unsupported configurations simply do not work. All interfacing to the UUT is accomplished by making calls to the GSE interface 114. Performing UUT control is therefore operated via the test properties file 152.

The GSE interface 114 is structured such that as new hardware is added to the user's test platforms, the responsible hardware engineer or system software engineer provides interface functions to the vendor-supplied hardware drivers 130 and updates the framework hardware abstract interface 128 to use the new functions. See, for example, the block diagram illustrated in FIG. 13 and discussed herein. The GSE interface 114 is expected to grow as new hardware is needed for test projects. Once added to the test framework of the invention, the new hardware becomes accessible by all test projects. Use of these functions is specified in the test properties file 152, along with relevant parameters. ARINC 429, ComPort and Analog example interface functions are as follows:

| | | |
|---|---|---|
| ARINC429 Init | COMPORT Open | NIDAQ Init |
| ARINC429 Out | COMPORT Out | NIDAQ Out |
| ARINC429 In | COMPORT In | NIDAQ In |
| | COMPORT Close | |

The following provides a more detailed description of the data-empowered test architecture 100 of the invention including: coupling of the ARINC 625 test implementation specification; defining tests in a data-driven architecture; generic tests, the test framework component 102; and the hardware abstract interface component 128.

FIG. 7 illustrates a sample test description 157 of the test implementation specification 156 for a Flight Data Recorder Analyzer Mode Test of the Assignee. As discussed above, the test implementation specification 156 is one of two separate specifications defined by ARINC 625-1 and describes how the test specification (TS) 158 is implemented on specific GSE and provides shop verification of the test specification 158. The ARINC 625-1 test implementation specification 156 is one of the two parts of the reuse library 112 and provides a detailed description from a tester perspective of all tests performed during Acceptance Test, along with the tester resources 176 utilized by each test. As illustrated in FIG. 7, one sample implementation of test descriptions 157 within the test implementation specification 156 provides the unique test Identification (test ID) number 159 that is traceable to the test specification 158 and referenced in the test report 110. The test ID number 159 is also used by the test properties and Sequence control files 152, 154 (shown in FIG. 6). The sample implementation of test description 157 illustrated in FIG. 7 provides UUT signal data 160 and subassembly (SRU level) data 162, a textual description 164 of the test; and a test procedure 166 for the test that may be in the form of the vocabulary-based pseudo-code of the test implementation specification 156. A listing of the vocabulary of test implementation specification's vocabulary-based pseudo-code is shown by example and without limitation in Table 4, as formatted according to: COMMAND <required data> [optional data] [optional text]. These vocabulary words are used to formalize the syntax for use in describing test procedures. When the vocabulary words appear as shown in Table 4, they convey the given definitions.

TABLE 4
Vocabulary of ARINC 625-1 Test Implementation Specification 156

| COMMAND | DESCRIPTION |
|---|---|
| ABORT: | Exit the current test. |
| CAPTURE: | Retain information such as time of an event or |
| | intermediate value for a calculation. |
| CLOSE <equip_name>: | Close a device such as a ComPort. This is the |
| | opposite of the OPEN mnemonic. |
| <COMMAND> END | Command a continuous operation such as IN or |
| <equip_name>: | OUT to end. |
| COMPARE, VERIFY: | Pass/Fail test of measured value to defined limits. |
| CONTAIN(S): | A string parameter ‘contains’ a substring. |
| | Example: “Abcdefg” CONTAINS “code”. |
| DEFINE: | Defining a procedure that is associated with a |
| | mnemonic. The procedure definition may include |
| | parameters that will be assigned or given values |
| | for a given context (parameter substitution). |
| DISCARD: | Disregard data read in from the UUT, RS-232 or |
| | other device. In some cases extra data is returned |
| | that is not needed by the test but that must be read |
| | in order to find the correct data in the data stream. |
| ELSE: | Alternate conditional branch. |
| EXIT: | Exit LOOP or subroutine. |
| TF expression, action: | Conditional branching at a procedural level, |
| | “expression” resolves to a Boolean True/False |
| | and “action” may be a key word. E.g. IF Mod |
| | level EQ A, PERFORM . . . |
| IN <equip_name> [count□period]: | Input data, using protocol appropriate for the |
| | signal type or instrument, either “count’ times or |
| | for “period”. If “count” and “period” are not |
| | defined, then input continues until an END |
| | command is performed. |
| INIT <equip_name>: | Send initialization parameters to an instrument or |
| | device. |
| LOOP [UNTIL]: | Repeat the procedure UNTIL a condition is met. |
| NOTIFY [message]: | Notify the user of a condition or event. Provide |
| | the user with instructions. |
| OPEN <equip_name>: | Open a device such as a ComPort. This is a |
| | special case of the INITIALIZE command since it |
| | has a corresponding CLOSE command. This is |
| | the opposite of the CLOSE mnemonic. |
| OUT <equip_name> [count□period]: | Output data, using protocol appropriate for the |
| | signal type or instrument, Either “count” times or |
| | for “period”. If “count” and “period” are not |
| | defined, then output continues until an END |
| | command is performed. |
| REPEAT i | Execute associated procedure either “count” times |
| [count□ FOR EACH] | or once FOR EACH element in a specified list or |
| | table. “i′” is the zero-based iteration count |
| | variable that can be referenced inside the |
| | procedure. |
| REPORT: | Write the specified message to the test log. |
| RESET <equip_name>: | Reset a condition, using the named equipment, as |
| | defined in text. This command typically resets a |
| | previously SET condition. For digital signals, |
| | RESET places the digital output in its Inactive |
| | state. |
| SCALE <reading> : conversion: | Perform provided scaling on the specified |
| | reading. |
| SET <equip_name>: | Set a condition, using the named equipment, as |
| | defined in text. For digital signals, SET places the |
| | digital output in its Active state. |
| UNTIL: | Defines a condition that will end a LOOP. |
| WAIT: | Delay flow of test for defined time. May use min |
| | or error limits. |

The test implementation specification's test procedure 166 and its pseudo-code are tightly integrated into the data-empowered test architecture 100 of the invention in the form of the test procedure interpreter 124 for processing the test procedure 166 vocabulary. By directly reading this pseudo-code, the data-empowered test architecture of the invention drastically reduces test program development time by eliminating the time-consuming coding phase from the test development process. By using the control files 108, along with the test procedure interpreter 124 and hardware abstraction, the test implementation specification's test procedure 166 becomes the test program code.

As illustrated in FIG. 7, all test data present in the test implementation specification's test description 157 optionally resides in one location through the use of a proprietary or other database.

FIG. 8 illustrates the common test procedure source for both the test implementation specification 156 and test properties file 152 wherein the test procedure 166 data are optionally exported from the database to both the test implementation specification 156 and the test properties control file 152, in their respective formats. As illustrated by the example, the test requirements are entered by a requirements editor 168 into a proprietary or other database 170. The test procedure 166 portion of the test implementation specification 156 is operated and is output in the format of the test implementation specification 156 and in the format appropriate for the test properties file 152, illustrated by example and without limitation as a CSV/XML format.

This approach also solves several problems that have historically plagued pseudo-code of the prior art. For example, in the prior art the pseudo-code and the actual code often diverge as changes are made to output the test procedure in one format and not the other; in the prior art the pseudo-code cannot be executed to ensure its accuracy; and in the prior art the pseudo-code implementation, i.e., the vocabulary, varies between different test projects.

The data-empowered test architecture 100 of the invention utilizes a database report to create both the test properties control file 152 and the test implementation specification's test description 157 so that synchronization problems, which are inherent in the prior art, are eliminated in the present invention. In contrast to the prior art, accuracy is ensured in the present invention because the files are actually tested as part of test program verification. Unlike the prior art, the data-empowered test architecture 100 of the invention utilizes a database with common data fields and ARINC 625-1 document templates with a predefined vocabulary that ensures consistency across different test projects.

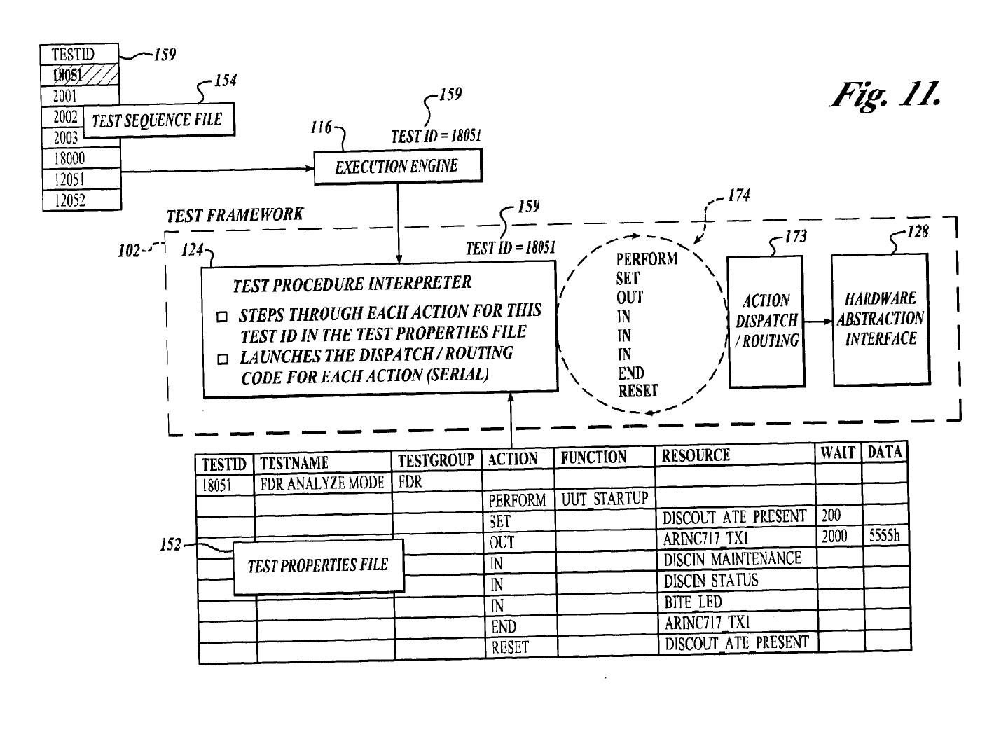

FIG. 9 is an exemplary illustration of one embodiment of the test procedure portion 166 of the test implementation specification's test description 157 illustrated in FIG. 7 wherein the example illustrated is an analyze mode test procedure of the invention. The test procedure 166 illustrated in FIG. 9 identifies components of a test: tester resources 176; test data; and actions 115: Close, Init, Perform, Start, End, Open, Reset, Stop, In, Out, and Set. WAIT and VERIFY are verbs defined in the vocabulary of the test implementation specification 156 but are not “actions” 115 as defined herein.

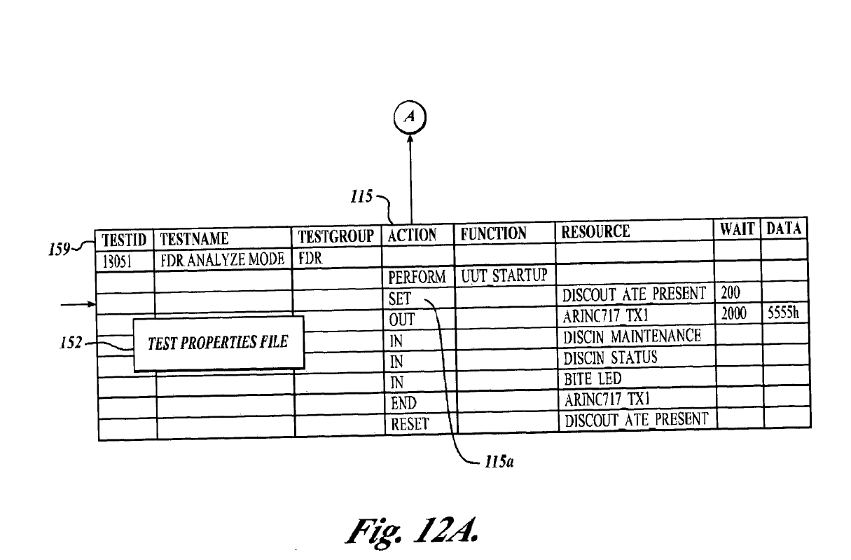

Creating tests is the sole activity of traditional test program development of the prior art. FIG. 10 illustrates that in traditional prior art systems, indicated generally at 1, each test tends to be a custom test with parameters, test equipment hardware resources and tolerances embedded in the test code. Making simple changes in the traditional prior art systems can and often does require touching large numbers of tests, which is time consuming and error-prone for both new development and maintenance.

FIG. 10 compares traditional signal-specific tests of the prior art systems 1 to the generic data-driven test provided by the data-empowered test architecture 100 of the invention. FIG. 10 illustrates that, by contrast to traditional prior art systems, any test is just another form of externally configurable code in the data-empowered test architecture 100 of the invention. Because the data-driven test of the invention is configured according to the test properties control file 152, the data-driven test 172 of the invention is a generic test. Utilization of data-driven tests that are structured as externally configurable code allows tests in the data-empowered test architecture 100 of the invention to move away from signal-based tests, such as a specific ARINC 429 receiver or an analog output test, as practice in the prior art.

The data-empowered test architecture 100 of the invention is able to utilize the generic test interpreter implemented by the test procedure interpreter 124 of the invention because testing according to the data-empowered test architecture 100 is based on a set of actions 115 that describe the generic test in a signal-independent manner. The generic data-driven test 172 of the invention is capable of performing tests that in prior art systems required custom coding. All tests defined in the sample test properties control file 152 shown in Table 5 can be executed as a generic data-driven test 172 according to the data-empowered test architecture 100 of the invention.

TABLE 5
Sample Test Properties (test parameters not shown)

| TestID | TestName | TestGroup | Action | ResourceName | Data |
|---|---|---|---|---|---|
| 1001 | RS-232 RX | RS-232 | Open | COM1 | |
| | | | Open | RS232_MONITOR | |
| | | | Set | RELAY_232_422 | |
| | | | Out | COM1 | 11485 |
| | | | In | RS232_MONITOR | |
| | | | Close | COM1 | |
| 1002 | RS-232 TX | RS-232 | Open | COM1 | |
| | | | Open | RS232_MONITOR | |
| | | | Set | RELAY_232_422 | |
| | | | Out | RS232_MONITOR | 11485 |
| | | | In | COM1 | |
| | | | Close | COM1 | |
| 1051 | RS-422 RX | RS-422 | Open | COM1 | |
| | | | Open | RS232_MONITOR | |
| | | | Reset | RELAY_232_422 | |
| | | | Out | COM1 | 54321 |
| | | | In | RS232_MONITOR | |
| | | | Close | COM1 | |
| 1052 | RS-422 TX | RS-422 | Open | COM1 | |
| | | | Open | RS232_MONITOR | |
| | | | Reset | RELAY_232_422 | |
| | | | Out | RS232_MONITOR | 54321 |
| | | | In | COM1 | |
| | | | Close | COM1 | |
| 1101 | ARINC 429 RX- | ARINC429 | Init | ARINC429_TX20 | |
| | | | Init | ARINC429_1 | |
| | | | Out | ARINC429_TX20 | 232323 |
| | | | In | RS232_MONITOR | |
| 1102 | ARINC 429 TX- | ARINC429 | Init | ARINC429_RX20 | |
| | | | Init | ARINC429_1 | |
| | | | Out | RS232_MONITOR | 232323 |
| | | | In | ARINC429_RX20 | |
| 18051 | FDR Analyze | FDR | Perform | | |
| | | | Set | DISCOUT_ATE_PRESENT | |
| | | | Out | ARINC717_TX1 | 5555 |
| | | | In | DISCIN_MAINTENANCE | |
| | | | In | DISCIN_STATUS | |
| | | | In | BITE_LED | |
| | | | End | ARINC717_TX1 | |
| | | | Reset | DISCOUT_ATE_PRESENT | |
| 2001 | Power Supply, | Power Supply | Init | PS_AC1 | |
| | Voltage | | Set | RELAY_PSHIGH | |
| | | | Set | RELAY_PSLOW | |
| | | | In | DMM | |
| | | | Reset | RELAY_PSHIGH | |
| | | | Reset | RELAY_PSLOW | |

Examination of the FDR Analyze mode (test ID 18051) sample in Table 5 shows a set of actions 115 to be performed using the specified test equipment hardware resources 176 and data, the actions 115 to be performed being: Perform, Set, Out, In, End, and Reset.

FIG. 11 illustrates test execution using the test procedure interpreter 124 of the invention. As illustrated in FIG. 11, the test procedure interpreter 124 reads all actions 115 defined for a given test ID 159 from the test properties file 152, and then executes these actions 115 in the order they are listed. The test procedure interpreter 124 steps through each action 115 for the given test ID 159 in the test properties control file 152, and for each action 115 launches in serial format action dispatch/routing code that is embodied in the action dispatch/routing module 173. The Perform, Set, Out, In, In, In, End, and Reset actions 115 are thus performed as indicated generally at 174 before the dispatch/routing code launches the action 115 to the framework hardware abstract interface module 128.

The test framework software code embodied in the test framework module 102 of the invention provides the interface between the execution engine 116 and the hardware abstract interface 128. The test framework module 102 includes the test procedure interpreter 124; the action dispatchers 126 and routers 180, shown in FIG. 13 and discussed in detail below, both embodied in code in the dispatch/routing module 173; and the hardware abstract interface module 128. The test framework module 102 processes the actions 115 present in the test properties file 152, wherein only one action dispatcher 126 is provided per vocabulary action 115 of the ARINC 625 test implementation specification 156.

FIG. 12 illustrates the operation of the test framework 102 embodied in a block diagram wherein the SET action 115a is illustrated. The test procedure interpreter 124 steps through the test properties control file 152 using the test ID 159 as supplied by the execution engine 116, and launches the test procedure interpreter 124 for each of the actions 115 found. As the test procedure interpreter 124 determines what action 115 to perform, control is passed to the appropriate action dispatcher 126 for further processing. FIG. 12 illustrates the operation of the test framework 102 and test procedure interpreter 124 processing for the Set action 115a, wherein the Set action dispatcher is indicated at 126a.

FIG. 13 illustrates the interface of the test framework 102 of the invention with the hardware abstract interface 128 of the invention as embodied in a block diagram.

An action dispatcher 126 is provided in the data-empowered test architecture 100 of the invention for each action 115 provided in the test implementation specification 156, including: Set AD (action dispatcher) 126a, Reset AD 126b, Perform AD 126c, Opeti AD 126d, Out AD 126e, Init AD 126f, In AD 126g, and Close AD 126h, as shown in FIG. 12. Each action dispatcher 126a-h possesses a set of tester signal-types 178 that it is capable of accessing. For example, the Set action dispatcher 126a may only support a Discrete Output tester signal type 178a, while the Out action dispatcher 126e may support ARINC 429, ARINC 717, RS-232, RS-422 and AnalogOut tester signal types, or other signal types. The action dispatcher 126 determines what signal-type 178 is being accessed by the test procedure step of an operation by reading test equipment hardware resource data 176 from the hardware properties control file 134. The action dispatcher 126 thus uses the hardware resource data 176 as an index into the hardware properties control file 134 and obtains the signal type 178 from the hardware properties control file 134. The action dispatcher 126 then passes control to an appropriate abstraction router 180 in the hardware abstract interface 128.

FIG. 14 illustrates the operation of the hardware abstract interface 128 of the invention with commercial off-the-shelf vendor drivers 130 as embodied in a block diagram. The hardware abstract interface 128 provides one abstraction router 180 per tester signal-type 178. The hardware abstract interface module 128 also provides one abstraction handler (AH) 182 per signal-type hardware driver.

The data-empowered test architecture 100 of the invention minimizes the effect of hardware changes on the test program by taking advantage of industry initiatives such as IVI, VISA and NI-DAQ. These well-known and common interfaces provide access to a family of cards, thereby allowing different cards to be installed without affecting the test program. The hardware abstract interface 128 is updated to enable the test program to access new hardware that is not supported by these initiatives. Once updated, all projects then accommodate the new hardware by upgrading to the revised version of the data-empowered test architecture 100.

The abstraction routers 180 accesses the hardware properties control file 134 to determine the hardware resource card-type indicated at 184. The abstraction routers 180 then direct the test procedure action data and parameters to the appropriate abstraction handler 182. The tester hardware properties control file 134 is queried to determine the card-type 184, as illustrated in FIG. 14. The card-type 184 is determined as a function of a card-type identifier 185, such as “NI-3243” shown. For vendors that supply common drivers to all cards they manufacture, this card-type identifier 185 may just be the manufacturer's name. For other vendors, the card-type identifier 185 specifies more detailed identification information such as a card name or identification number.

Since the data-empowered test architecture 100 of the invention may support multiple cards for a given signal-type 178, the abstraction router 180 may have several abstraction handlers 182 for that given signal-type. The card-type property 184 retrieved from the hardware properties file 134 is used to select the correct abstraction handler 182a.

As an example, FIG. 14 illustrates the interaction of the Discrete Out abstraction router 180a and the NI-3243 abstraction handler 182a for an exemplary NI-3243 vendor-supplied hardware driver 130a.

The abstraction handler (AH) 182 performs the function of routing data and parameters to and from the vendor-supplied hardware drivers 130. The data-empowered test architecture 100 of the invention provides an abstraction handler 182 for each vendor driver to be accessed. These handlers 182 are the only place in the code of the data-empowered test architecture 100 where calls to specific hardware are made. The abstraction handlers 182 determine which channel, relay or address to access from information stored in the hardware properties file 152, as illustrated in FIG. 14. Any data or properties sent to the hardware via the abstraction handler 182 is obtained from the test properties control file 152. FIG. 14 also illustrates an exemplary interaction between the NI-3243 abstraction handler 182a and the NI-3243 vendor driver 130a for the SET action 115a.

The abstraction handlers 182 are either built into the test framework 102 software code, or they are self-contained Dynamic Link Libraries (DLLs) that dynamically link into data-empowered test architecture 100. The self-contained Dynamic Link Libraries enable abstraction handlers 182 to be added by project development groups without changes to the source code of the data-empowered test architecture 100.

FIG. 15 is a block diagram that summarizes by example steps of the test procedure of the data-empowered test architecture 100 of the invention for interfacing with low-level vendor-supplied hardware drivers 130. The example illustrated in FIG. 15 shows a variety of test procedure steps using the Out action 115 and how the test procedure steps are processed by the data-empowered test architecture 100 of the invention.

As test procedure steps are processed by the test procedure interpreter 124 of the invention, the action 115 specified by the procedure step is activated in the form of an action dispatcher 126. The action dispatcher 126 determines the tester resource signal-type 178 to be used to complete the procedure step by reading the tester resource 176 signal-type from the hardware properties control file 134, and launches the appropriate signal-type abstraction router 180. The abstraction router 180 determines the card-type 184 for executing the procedure step by reading the tester resource card-type 184 from the hardware properties file 134, and calls the appropriate abstraction handler 182. The abstraction handler 182 then interfaces with an appropriate low-level vendor-supplied hardware driver 130.

The data-empowered test architecture 100 of the invention is estimated to be capable of performing approximately ninety-percent of current testing without modifications. The data-empowered test architecture 100 supports the remainder ten-percent by accommodating additional “helper” functions and provides for insertion of traditional tests using the Perform action, shown in FIG. 11.

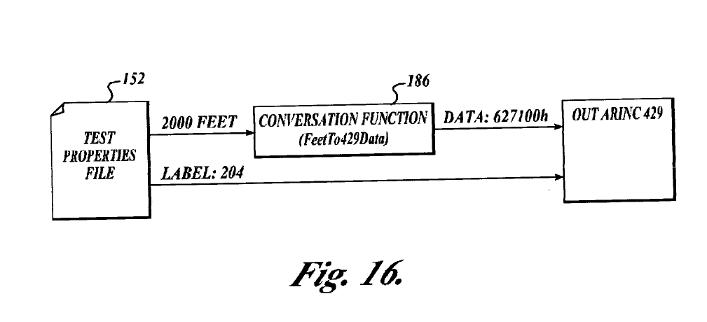

FIG. 16 illustrates an exemplary “helper” function 186 as a data conversion function, such as a function converting a feet measurement value to an ARINC 429 value prior to transmission. According to the exemplary “helper” conversion function 186 in FIG. 16, Out and In action dispatchers 126e and 126g automatically check the test properties file 152 for helper functions. These “helper” functions 186 are added to the code of the data-empowered test architecture 100 of the invention if they can logically be used across test projects.

The data-empowered test architecture 100 of the invention is designed to support testing of multiple UUTs either in an ATP or in a Highly Accelerated Stress Screening (HASS) environment. Such conditions cause the data-empowered test architecture 100 to have a robust operating system capable of preemptive multi-tasking and multi-threading. Operating systems that are less than robust or only emulate multitasking functionality are not believed to be suitable. Operating systems that suffer limited availability of drivers for the tester hardware also are believed to be unsuitable. A preferred choice of operating system is mature so that a large number of drivers are available for the tester hardware and the operating system is less susceptible to yearly updates and major changes. A preferred operating system permits easy to access the World Wide Web or Internet and limits nuisance passport-type prompts.

Programming language for use in practicing the data-empowered test architecture 100 of the invention is selected as providing control over execution, such that the execution is data flow driven rather than event driven, and is controllable from an external executable program. The programming language does not require special training because the data-driven features of the data-empowered test architecture 100 of the invention results in virtually no test program coding, which moots the development time-savings of a commercially available graphical programming language.

The data-empowered test architecture 100 of the invention is a radical departure from prior art systems. The data-empowered test architecture 100 for the first time creates software in conditions where continuous improvement and feature enhancement is a planned activity. This is in sharp contrast to prior art processes where test programs are released to meet schedules and are never revisited except to fix bugs or to support new LRU product features. Thus, the prior art operates in a “release and forget” mode wherein poorly designed tests are rarely fixed.

Improving test program testing rigor and comprehensiveness is simplified by the data-empowered architecture 100 of the invention. New or improved tests are quickly inserted into the test properties file 152 as they are developed. All test programs according to the data-empowered test architecture 100 of the invention can also quickly incorporate additional features and enhancements made to the data-empowered test architecture 100 itself.

A test properties database 188 (shown in FIG. 6) is optionally provided separate from the data-empowered test architecture 100 project framework and coupled to the test properties file 152 for storing all tests and test data for all data-empowered test architecture test projects. The optional test properties database 188 permits either the test developer or the LRU product designer to enter test data and properties. The test properties file 152, which is used as the test program according to the data-empowered test architecture 100 of the invention, is generated as a database report.

An initial embodiment of the data-empowered test architecture 100 of the invention may not use a test properties database. Rather, Comma Separated Value (CSV) files provide the data for this initial embodiment. Prior to creating a test properties database 188, the control files 108 are provided in XML spreadsheet format and are edited with a proprietary software tool. An alternative embodiment of the invention utilizes the optional test properties database 188 and a server-side application to create the XML spreadsheet files. The format of the control files 108 is abstracted from the test program by means of Component Object Model (COM) components so that as these files are updated to XML format, only the COM components will require updating.

One initial embodiment of the data-empowered test architecture 100 of the invention uses Comma Separated Value (CSV) files as the data source. Other embodiments of the data-empowered test architecture 100 of the invention provide test properties files 152 and hardware properties file 134 that support the XML file format. Addition of XML support does not affect existing test programs created according to the data-empowered test architecture 100 of the invention since CSV continues to be supported and because the data sources are abstracted from the test program via the hardware properties reader 132 and test properties reader 136 components of the software components module 106.

The data-empowered test architecture 100 of the invention is designed as a framework for all test projects. Because of this, one or two system software engineers skilled in an appropriate programming language can and should perform maintenance of the framework. In fact, all shared code within the data-empowered test architecture 100 of the invention, including the code of the test framework module 102, test executive module 104 and software components module 106, can and should be controlled and maintained by this software system group. This group can and should also be responsible for training and aiding test program engineers in the use of the data-empowered test architecture 100 of the invention. This group can and should also continue to upgrade the data-empowered test architecture 100 by adding features as appropriate and optionally assists in creating hardware abstract interface modules 128 when new hardware is added to a test platform.

The individual test program designer, or the LRU product designer, can perform test program creation by creating the control files 108 of the data-empowered test architecture 100. Test program creation does not require coding experience or knowledge. However, if some project-specific coding is to be performed, the test program designer should be skilled in the appropriate programming language or have access to help with project-specific coding needs.

The method of the invention as described herein is optionally embodied in a computer program product stored on a computer-usable medium, the computer-usable medium having computer-readable code embodied therein for configuring a computer, the computer program product including computer-readable code configured to cause a computer to generate a plurality of the test actions 115; computer-readable code configured to cause the computer to access the plurality of the actions 115; computer-readable code configured to cause the computer to identify a test equipment hardware resources 176 associated with a current one of the action 115; and computer-readable code configured to cause the computer to interface with an external hardware driver 130 as a function of the test equipment hardware resources 176 associated with the current action 115.

According to one embodiment of the invention, the computer-readable code of the computer product that is configured to cause a computer to interface with the external hardware driver 130 also includes computer-readable code configured to cause a computer to do all of the following: determine the signal type 178 corresponding to the identified test equipment hardware resource 176; access as a function of the signal type 178 one of the external control files 108 having test equipment hardware resource card-type 184 information contained therein, i.e., the hardware properties control file 134; and determine the test equipment hardware resource card-type 184 information as a function of the card-type identifier 185.

The computer-readable code of the computer product that is configured to cause the computer to generate a plurality of test actions 115 includes computer-readable code configured to cause a computer to receive one or more of the test ID numbers 159 from a stored list of the test ID numbers 159, and to generate the plurality of test actions 115 as a function of the received test ID numbers 159.

The computer-readable code of the computer product also includes computer-readable code configured to cause the computer to perform the pass/fail analysis and to generate one or more of the test reports 110.

The computer-readable code of the computer product also includes computer-readable code stored in one or more of the software components 106 and configured to cause the computer to interface between the computer-readable code configured to cause it to generate the plurality of test actions 115 and the computer-readable code configured to cause the computer to access the plurality of test actions 115.

While the preferred embodiment of the invention has been illustrated and described, it will be appreciated that various changes can be made therein without departing from the spirit and scope of the invention.

1. A data-empowered test program architecture comprising:
a test executive software module;
a test framework software module having externally configurable generic software code and being coupled for interaction with the test executive software module;
a plurality of software components in a software components module coupled for interaction with the test framework software module and structured for outputting one or more test reports; and
one or more external control files coupled for configuring the generic software code of the test framework software module.

2. The architecture of claim 1 wherein the test framework software module further comprises a hardware abstraction interface.

3. The architecture of claim 1, further comprising an external reuse library having one or more test descriptions of common signal types and being coupled for generating the control files.

4. The architecture of claim 1 wherein the software components module further comprises one or more software components for interfacing between the one or more external control files and one or more of the test executive software module and the test framework software module.

5. The architecture of claim 1 wherein the software components module further comprises a pass/fail analyzer and report generator having one or more modes of pass/fail analysis and test reporting.

6. A data-empowered test program architecture comprising:
one or more external control files including an external control file having a list of test identification numbers;
a test executive module having an execution engine coupled to receive one or more test identification numbers from the list of test identification numbers for generating as a function of the one or more test identification numbers a plurality of test actions to be performed on a unit-under-test;
a test framework module accessing the plurality of test actions and associated test hardware resources as a function of the test identification numbers, the test framework module:
i) determining an identification of one of the test hardware resources associated with a current one of the test action,
ii) retrieving the identification of the associated test hardware resource,
iii) determining a signal type corresponding to the retrieved test hardware resource identification,
iv) accessing as a function of the signal type one of the external control files having test hardware resource card-type information, and
v) determining the test hardware resource card-type information as a function of a card-type identifier.

7. The architecture of claim 6 wherein the test hardware resource card-type information includes routing data and parameters for interfacing with an external hardware driver.

8. The architecture of claim 6, further comprising an external reuse library having a plurality of test descriptions corresponding to a plurality of different test signal types.

9. The architecture of claim 6, further comprising a plurality of software components for interfacing between the external control files and one or more of the test executive module and the test framework module.

10. The architecture of claim 9 wherein the plurality of software components further comprises one or more modes of pass/fail analysis and test reporting.

11. A data-empowered test program architecture comprising:
means for generating a plurality of test actions to be performed on a unit-under-test;
means for accessing the plurality of the test actions;
means for identifying a test hardware resources associated with a current one of the test action; and
means for interfacing with an external hardware driver as a function of identifying the test hardware resources associated with the current one of the test action.

12. The architecture of claim wherein the means for interfacing with an external hardware driver further comprises:
means for determining a signal type corresponding to the identified test hardware resource;
means for accessing as a function of the signal type an external control file having test hardware resource card-type information contained therein; and
means for determining the test hardware resource card-type information as a function of a card-type identifier.

13. The architecture of claim 11 wherein the means for generating a plurality of test actions further comprises means for generating the plurality of test actions as a function of one or more test identification numbers received from a list of test identification numbers.

14. The architecture of claim 11 wherein the means for generating a plurality of test actions to be performed on a unit-under-test further comprises means for generating a plurality of control files for configuring software code for generating the plurality of test actions.

15. The architecture of claim 14 wherein the means for generating a plurality of control files further comprises means for generating one or more of the control files as a function of one or more test descriptions of signal types contained in an external reuse library.

16. The architecture of claim 11, further comprising means for performing pass/fail analysis.

17. The architecture of claim 16, further comprising means for generating one or more test reports.

18. A computer program product comprising:
a computer usable medium having computer-readable code embodied therein for configuring a computer, the computer program product comprising:
computer-readable code configured to cause a computer to generate a plurality of test actions;
computer-readable code configured to cause the computer to access the plurality of the test actions;
computer-readable code configured to cause the computer to identify a test hardware resource associated with a current one of the test action; and
computer-readable code configured to cause the computer to interface with an external hardware driver as a function of the test hardware resources associated with the current one of the test actions.

19. The computer product of claim 18 wherein the computer-readable code configured to cause a computer to interface with an external hardware driver further comprises computer-readable code configured to cause a computer to:
determine a signal type corresponding to the identified test hardware resource;
as a function of the signal type, access an external control file having test hardware resource card-type information contained therein; and
as a function of a card-type identifier, determine the test hardware resource card-type information.

20. The computer product of claim 18 wherein the computer-readable code configured to cause a computer to generate a plurality of test actions further comprises computer-readable code configured to cause a computer to receive from a list of test identification numbers one or more test identification numbers, and to generate the plurality of test actions as a function of the received test identification number.

21. The computer product of claim 18, further comprising computer-readable code configured to cause a computer to perform a pass/fail analysis.

22. The computer product of claim 21, further comprising computer-readable code configured to cause a computer to generate one or more test reports.

23. The computer product of claim 18, further comprising computer-readable code stored in one or more software components and configured to cause a computer to interface between the computer-readable code configured to cause a computer to generate a plurality of test actions and the computer-readable code configured to cause a computer to access the plurality of the test actions.
